(19) United States
(12) Patent Application Publication
(10) Pub. No.: US 2005/0271383 A1
(43) Pub. Date: Dec. 8, 2005

(54) Development processing apparatus for silver halide color paper and method for processing silver halide color paper

(75) Inventor: Kazuaki Yoshida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/147,244

(22) Filed: Jun. 8, 2005

(30) Foreign Application Priority Data
Jun. 8, 2004 (JP) P.2004-169814
Jun. 8, 2004 (JP) P.2004-169815

(51) Int. Cl. G03D 3/08

(52) U.S. Cl. 396/622

(57) ABSTRACT

A development processing apparatus for a silver halide color paper, comprising: a first processing tank for processing a light-sensitive material with a color developer; a second processing tank for successively processing the light-sensitive material with a bleaching solution; a third processing tank for successively processing the light-sensitive material with a solution having a fixing ability; and a passage between the second processing tank and the third processing tank, wherein the passage is sealed while the passage allows to pass the light-sensitive material, and the light-sensitive material is conveyed in a solution without contacting air through the passage. And a method for processing a silver halide color paper, wherein the light-sensitive material is conveyed in a solution without contacting air, and wherein a sum of a processing time is 12 seconds or shorter.

### BACKGROUND OF THE INVENTION

1. Field of the Invention

The present invention relates to an apparatus for development processing silver halide color paper and a method for processing silver halide color paper (hereinafter also referred to merely as “color paper”) and, in particular, to a space-saving apparatus and method for development processing, which enables short-time processing of color paper with maintaining both the quality of finished print obtained by the processing and processing adaptability of the photographic processing solutions.

2. Description of the Related Art

In recent years, there has been spread a business model of providing an automatic developing machine, called “minilabo”, for processing light-sensitive materials at a camera store for accelerating printing service for customers in place of collection and delivery between a camera store and a laboratory. It is required for such minilabo to permit enough high speed processing to hand over finished prints on the spot to a customer having brought exposed light-sensitive materials with eliminating the necessity of again visiting the store. In particular, photographing media which are brought to a camera store to produce color prints include not only silver salt photographic films but electronic image-recording media recorded by using a digital camera as well. Therefore, a service giving a “simple and rapid” impression has become necessary for making new customers to feel familiar.

In order to give the “simple and rapid” impression, such color copying methods as an ink jet method, a dye thermal transfer method and a color electrostatic photography are adapted. These methods, however, fail to produce images with a pictorial image quality, and hence customers being satisfied with such images are limited.

As means for producing prints to be used in the minilabo capable of realizing both image quality and “simple and rapid” characteristics, there has been proposed a thermally developing color diffusion transfer method (trade name: Pictorocolor), and an image-forming material for the method and the printer technology are described in, for example, Kosugi, “Netsugenzo Kakusantenshagata Kara Purinta”; Nihon Shasin Gakkaishi, 64(5), pp. 292-296 (2002). However, this method produces a waste of so-called donor film and there arises the necessity of discarding it, thus the method being disadvantageous in this point.

On the other hand, there has been proposed a device which can conduct the processing of color paper excellent in quality simply and rapidly. For example, JP-A-7-234488 discloses a technique of shortening the time for a light-sensitive material to be conveyed outside the processing tanks by connecting light-sensitive material-conveying passages between each of the developing, bleach-fixing and rinsing tanks with a micro-gap and a liquid leakage-proof nozzle, and it is shown that a light-sensitive material containing a specific magenta coupler can be processed in 63 seconds at the shortest. Further, JP-A-6-130617 discloses a rapidly processing apparatus wherein more space saving can be attained by providing a liquid leakage-proof nozzle between each of the processing tanks on the above-described passage for conveying a light-sensitive material to thereby directly connect the processing tanks to each other and providing the processing tanks in a vertical relation with each other. However, the technique disclosed in the above mentioned JP-A-7-234488 can be applied to only a limited light-sensitive material, and has a problem with respect to maintenance of the gas-touched nozzle due to the micro-gap structure formed between the tanks. In this point, the apparatus disclosed in the above mentioned JP-A-6-130617 is superior, but this apparatus also requires for the liquid level in the tank in contact with a gas phase to be taken care of. However, though these are also problems to be solved, a more essential problem is that acceleration of color paper processing by the techniques described in the above mentioned JP-A-7-234488 and JP-A-6-130617 is still insufficient for a customer to get color prints at a camera store without visiting the camera store again.

As is seen with the above-mentioned related art, no means have so far been found that meet the needs of recent minilabo customers in the points of pictorial image quality and rapidness of processing.

Further, since minilabos are placed at the camera store, the amount of waste, solid or liquid, is desirably minimized and, if possible, reduced to zero. With respect to this point, it is also required that an amount of overflow should be reduced during the processing and, therefore, the amount of a replenisher should be reduced. For example, in the processing method described in Examples of the above mentioned JP-A-7-234488, the bleach-fixing replenisher is replenished in an amount of as small as 35 mL per m² of the light-sensitive material. However, the replenishing amount is preferably more reduced.

### SUMMARY OF THE INVENTION

The invention has been completed with the above-mentioned background, and its object is to provide a processing apparatus for silver halide color paper which can provide a customer visiting a minilabo with both finished prints with a satisfactory image quality and “simple and rapid” impression.

Specifically, an object of the invention is to provide a processing apparatus for processing silver halide color paper and a method for processing silver halide color paper which (a) realizes rapid processing permitting to hand over finished prints to a customer on the spot, (b) requires only a small area allowable for a minilabo to install it, (c) ensures enough stability of processing solutions not to suffer deterioration of the processing solutions even during non-busy seasons, (d) constantly maintains image quality at a normal level, and (e) enables to reduce the sum of the amount of bleaching solution.

As a result of intensive investigation to develop a development processing apparatus and a method for processing silver halide color paper which can solve the above-mentioned problems, the inventor has found that the problems can be solved by combining specific processing steps, specific method of conveying a light-sensitive material and a processing apparatus realizing the conveying mechanism permitting the conveyance of the light-sensitive material.

That is, the above-mentioned objects can be attained by the invention of the following constitution.

(1) A development processing apparatus for a silver halide color paper, comprising
a first processing tank for processing a light-sensitive material with a color developer;
a second processing tank for successively processing the light-sensitive material with a bleaching solution;
a third processing tank for successively processing the light-sensitive material with a solution having a fixing ability; and
a passage between the second processing tank and the third processing tank,
wherein the passage is sealed while the passage allows to pass the light-sensitive material, and the light-sensitive material is conveyed in a solution without contacting air through the passage between the second processing tank and the third processing tank.

(2) The development processing apparatus as described in (1) above,

wherein the second processing tank and the third processing tank are provided in a vertical positional relationship with each other.

(3) The development processing apparatus as described in (1) or (2) above,
wherein a sum of a processing time for processing with the bleaching solution and a processing time for processing with the solution having the fixing ability is 12 seconds or shorter.

(4) The development processing apparatus as described in (3) above, wherein the sum is 10 seconds or shorter.

(5) The development processing apparatus as described in any of (1) to (4) above, further comprising:
a fourth processing tank for processing the light-sensitive material with a rinse solution; and
a passage between each adjacent two of the first processing tank, the second processing tank, the third processing tank and the fourth processing tank,
wherein the passage is sealed while the passage allows to pass the light-sensitive material, and the light-sensitive material is conveyed in a solution without contacting air through the passage.

(6) A method for processing a silver halide color paper using a development processing apparatus for a silver halide color paper as described in any of (1) to (5) above.

(7) A method for processing a silver halide color paper comprising:
subjecting a light-sensitive material to processing with a color developer;
subjecting the light-sensitive material to processing with a bleaching solution; and
subjecting the light-sensitive material to processing with a solution having a fixing ability,
wherein the light-sensitive material is conveyed in a solution without contacting air between the processing with the bleaching solution and the processing with the solution having the fixing ability, and
wherein a sum of a processing time of the processing with the bleaching solution and a processing time of the processing with the solution having the fixing ability is 12 seconds or shorter.

(8) The method as described in (7) above,
wherein the sum is 10 seconds or shorter.

(9) The method as described in (7) or (8) above,
wherein a sum of an amount of a bleaching replenisher to be replenished into a bleaching tank and an amount of a replenisher having a fixing ability to be replenished into a processing tank for the solution having the fixing ability is 35 mL or less per m² of a color paper.

(10) The method as described in any of (7) to (10) above,

wherein the sum of the amount of the bleaching replenisher and the amount of the replenisher having the fixing ability is 25 mL or less per m² of a color paper.

The processing apparatus and the processing method of the invention is characterized in that, in view of the processing steps, a bleach-fixing step is conducted subsequent to a color development processing, followed by a processing with a processing solution having a fixing ability (a fixing solution or a bleach-fixing solution), i.e., processing is conducted so that the processing with a bleaching solution and the processing with a fixing solution (or a bleach-fixing solution) are separately conducted (also referred to as “separate-type bleach-fixing), that, in view of the method of conveying a light-sensitive material, a conveying system is employed wherein a passage for a light-sensitive material sealed without contacting air (in a solution-tight state) is provided between a processing tank containing the bleaching solution and a processing tank containing the solution having a fixing ability so that a light-sensitive material can pass through the passage, with the light-sensitive material being conveyed from one tank to the other in the solution, and that the processing apparatus has a structure which permits the above-mentioned processing steps and the conveying system, further that the method for processing silver halide color paper comprises the combination of the above-mentioned processing steps and the conveying system in the solutions.

The apparatus and the method of the invention can exhibit the various effects of solving the problems to be described below due to the above-mentioned characteristics.

### BRIEF DESCRIPTION OF THE DRAWINGS

FIG. 1 shows a constructive view showing a typical embodiment of the development processing apparatus of the invention;

FIG. 2 shows a constructive view showing another typical embodiment of the development processing apparatus of the invention;

FIG. 3 shows a cross-sectional view showing one embodiment of a single blade for the passage of a light-sensitive material in the solution in accordance with the invention;

FIG. 4 shows a cross-sectional view showing another embodiment of a single blade for the passage of a light-sensitive material in the solution in accordance with the invention;

FIG. 5 shows a cross-sectional view showing one embodiment of a double blade for the passage of a light-sensitive material in the solution in accordance with the invention;

FIG. 6 shows a cross-sectional view showing another embodiment of a double blade for the passage of a light-sensitive material in the solution in accordance with the invention; and

FIG. 7 shows a cross-sectional view showing other embodiment of a double blade for the passage of a light-sensitive material in the solution in accordance with the invention.

### DETAILED DESCRIPTION OF THE INVENTION

The processing apparatus and the processing method of the invention is described in more detail below.

In view of processing steps, the processing apparatus of the invention is an apparatus to be applied to processing step wherein the bleaching processing is conducted subsequent to the color development processing, followed by the processing with a processing solution having a fixing ability (a fixing solution or a bleach-fixing solution). The processing step is a separate type bleach-fix processing step wherein the processing with the bleaching solution and the processing with the fixing solution are separated from each other. In view of the method of conveying a light-sensitive material, the apparatus is an apparatus which employs a system wherein a passage for a light-sensitive material sealed without contacting air (in a solution-tight state) is provided between the tank containing the bleaching solution and the tank containing the solution having a fixing ability, and the light-sensitive material is conveyed from one processing to the other processing tank.

That is, the processing apparatus of the invention is a processing apparatus having the structure and the conveying mechanism permitting the above-mentioned-processing step and the conveying system.

The processing method of the invention has the characteristic feature with respect to processing steps that processing with a processing solution having a fixing ability (fixing solution or bleach-fixing solution) is conducted after conducting color development processing and bleaching processing. This processing step is a separate type bleach-fixing step wherein processing with a bleaching solution is separated from processing with a fixing solution. Also, with respect to method of conveying the light-sensitive material, the processing method of the invention has the characteristic feature that the light-sensitive material is conveyed in the solution without contacting air between the bleaching processing and the processing with a solution having a fixing ability.

In particular, a functional disposition realizing the above-mentioned step and the conveying system can be made by disposing, in the processing apparatus of the invention, the processing tank containing the bleaching solution and the processing tank containing the solution having a fixing ability in a vertical relation with each other (i.e., the processing tank containing the bleaching solution is disposed on the processing tank containing the solution having a fixing ability). This disposition also serves to more reduce the floor area of the apparatus, thus being advantageous.

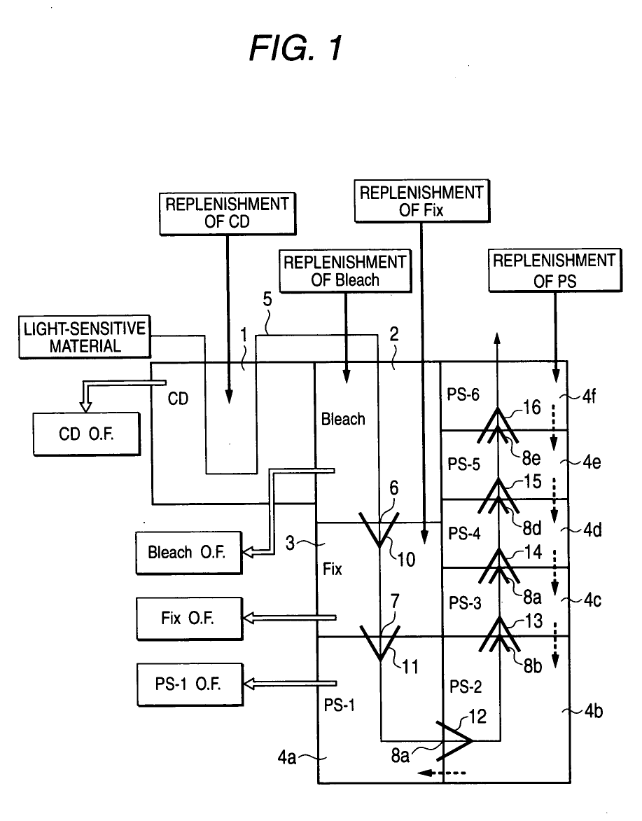

A typical embodiment of the development processing apparatus of the invention is described below by reference to FIGS. 1 to 7. In each of the following drawings, members are designated by member numbers, and processing tanks and processing solutions are designated by their names, with common members, processing tanks and processing solutions being designated by common member numbers, processing tank names and processing solution names.

In the typical embodiment of the development processing apparatus of the invention shown in FIG. 1, a color developing tank 1, designated by CD, containing a color developer, a bleaching tank 2, designated by Bleach, containing a bleaching solution, a fixing tank 3, designated by Fix, containing a fixing solution, and a sequence of 6 rinsing tanks 4a to 4f respectively containing the first to the sixth rinsing solutions supplied in a countercurrent cascade manner and designated by Ps-1 to Ps-6 are disposed as shown in the drawing. The color developing tank 1, the bleaching tank 2, the fixing tank 3 and the sixth rinsing tank 4f are to be respectively replenished with a color developing replenisher, a bleaching replenisher, a fixing replenisher and a rinsing replenisher as designated by framed letters.

Each of the color developing tank 1, the bleaching tank 2h, the fixing tank 3 and the first rinsing tank 4a is provided with a discharging means for discharging an overflow (O.F.) of each processing solution as designated by CD O.F., Bleach O.F., Fix O.F. or PS-1 O.F. When the rinsing replenisher is replenished into the sixth rinsing tank 4f as shown in the drawing as “PS replenishment”, the rinsing solution PS-6 within the sixth rinsing tank 4f becomes excessive and is moved to the fifth rinsing tank 4e. In such manner, the rinsing solution is moved in the countercurrent manner shown by the dotted arrows from the sixth rinsing tank 4f to the first rinsing tank 4a with conducting rising processing in each rinsing tank, and finally reaches the first rinsing tank 4a and then discharged as a rinse overflow PS-1 O.F.

The light-sensitive material designated by the framed letters is introduced into the color developing tank 1 along the light-sensitive material-conveying passage shown by the solid line and, after development processing, is introduced into the bleaching tank 2 along the passage 5 in the air to conduct bleaching processing. Subsequently, the light-sensitive material is conveyed to the fixing tank 3 through the passage 6 in the solution sealed without contacting air (in a solution-tight state) by a single blade 10, which permits to pass the light-sensitive material, provided between the bleaching tank 2 and the fixing tank 3. The light-sensitive material having been subjected to the fixing processing in the fixing tank is conveyed to the first rinsing tank 4a through the passage 7 in the solution sealed by a single blade 11 so that the light-sensitive material can pass therethrough and provided between the fixing tank 3 and the first rinsing tank 4a. The light-sensitive material is rinsed in the first rinsing tank 4a, then conveyed to the second rinsing tank 4b through the passage 8a in the solution sealed by a single blade 12 so that the light-sensitive material can pass therethrough and provided between the first rinsing tank 4a and the second rinsing tank 4b. Likewise, the light-sensitive material is conveyed from the second rinsing tank 4b through the sixth rinsing tank 4f through the passages 8b to 8e in the solution sealed by the blades 13 to 16, during which rinsing is conducted. The whole dip-processing steps for the light-sensitive material is completed in the sixth rinsing tank 4f, and the light-sensitive material is introduced into a drying step not shown to give finished color photograph (usually color print).

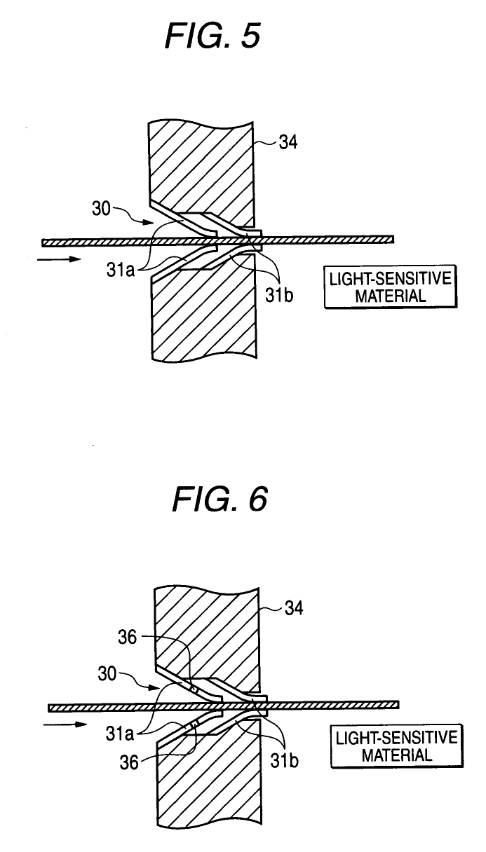

As the blades 13 to 16, double blades are used which are different from the single blades of blades 10 to 12. Although detailed descriptions thereon will be described later by reference to FIGS. 5, 6 and 7, the double blades serve to provide a higher level of solution-tightness and can reduce the amount of the upstream solution entrained to the downstream solution. In the specification, the phrase “passage sealed without contacting air (in a solution-tight state) which permits to pass the light-sensitive material” as used herein means, as is described hereinabove, a passage having a shutting ability which permits to pass a slight amount of the upstream solution through the gap of the sealing member such as a blade or other shutting means having the same shutting function. In other words, it is a passage which, when the solution pressure on the upstream side of the blade is higher than the solution pressure on the downstream side, permits migration of the solution through the blade in proportion to the pressure difference and, when the solution pressure on the upstream side and the solution pressure on the downstream side are the same, does not permit migration of the solution through the gap of the sealing member except for upon passage of the light-sensitive material (web). When the apparatus is out of operation, the slit which is provided in the tank wall and forms the passage for the light-sensitive material is shut up by the adjacent facing blades or by the one-piece blade and the tank wall surface adjacent to each other, and migration of the solution does not occur.

Also, though not shown in FIG. 1, an appropriate conveying means, for example, driving rollers such as conveyor rollers and nip rollers, facing free rollers and free rollers provided in a zigzag configuration is provided in the conveying passage in the solution.

In FIG. 1, migration of the rinsing solution in a cascade manner shown by the dotted arrows can be conducted by a means for tank-to-tank migration of the solution in the countercurrent manner which is formed, for example, by providing fine solution-passing pores permitting only a negligible level of mixing of the solutions between the tanks.

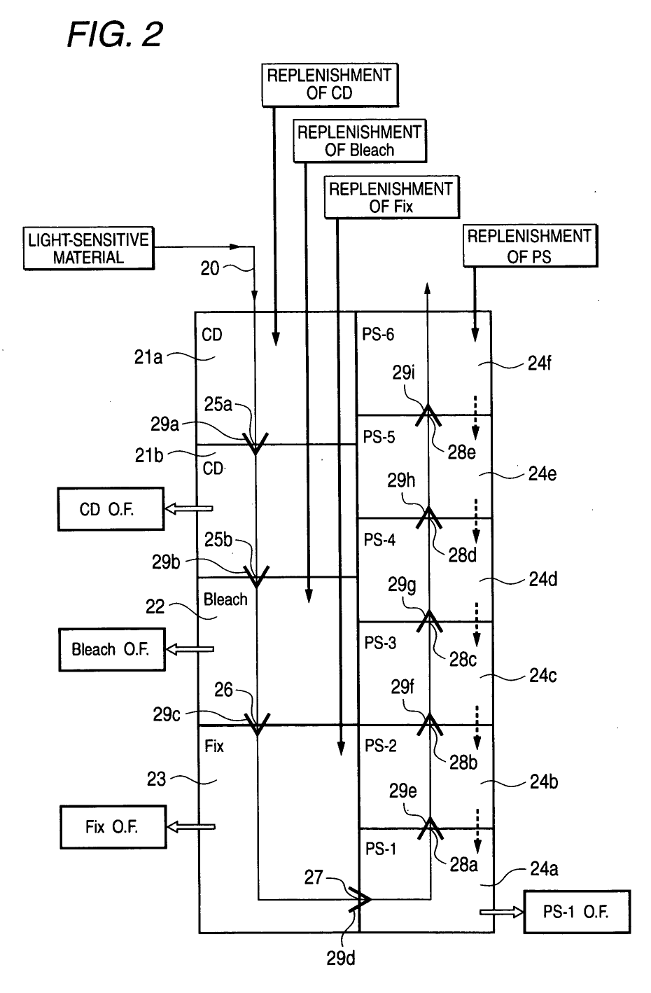

FIG. 2 shows another embodiment of the development processing apparatus of the invention.

In the development processing apparatus shown by FIG. 2, the color developing tank 21 containing the color developer designated by CD is divided into two tanks 21a and 21b via the passage 25a in the solution sealed without contacting air (in a solution-tight state) by the single blade 29a and is disposed on the bleaching tank 22. Further, a conveying passage 25b sealed by a single blade 29b is formed between the color developing tank 21b and the bleaching tank 22. With the vertical disposition of the color developing tanks 21a and 21b, the bleaching tank 22 and the fixing tank 23 as described above, the first rinsing tank 24a is disposed under the second rinsing tank 24b, thus the first rinsing tank 24a to the sixth rinsing tank 24f being disposed in a vertical configuration. As the blades 24a to 24f for the tank-to-tank passage of the light-sensitive material, single blades are used. Other constitution is the same as described with respect to FIG. 1. Even when member numbers for respective constituent members are different from the member numbers for constituent members used in FIG. 1, corresponding members exert the same functions, thus descriptions therefor being omitted. Also, flow of the processing of the light-sensitive material, addition of a replenisher, and discharge of an overflow are the same as those with respect to the development processing apparatus shown in FIG. 1, thus descriptions therefor being omitted.

The apparatus of this embodiment is more excellent than the apparatus shown in FIG. 1 in that, since the color developing tank is directly connected to the bleaching tank by the passage sealed by the blade in place of conveyance in the air, the apparatus of this embodiment depresses air oxidation, shortens the processing time and reduces the area for placing the processing apparatus. However, both apparatuses meat the requirements specified in the invention, and detailed descriptions to be given hereinafter apply to all apparatuses of the invention including these two apparatuses.

Next, the blades for providing the passage in the solution for the light-sensitive material between the processing solutions are described below. The blades are fit to the passage so that the tip portions thereof come into close contact with each other when no light-sensitive material is passed therethrough. When the light-sensitive material passes therethrough, the tip portions are press-opened upon entering of the light-sensitive material. The blades preferably have a base portion to be fit to the passage and a free end (also referred to as “tip portion”) having a thickness gradually reduced toward the tip, though the thickness may be about the same from the base portion to the tip portion. The average oblique angle of the blade to the surface of the light-sensitive material is generally from about 10 to about 70°, particularly preferably from about 20 to 45°. Also, the length of the blade from the base portion to the tip is preferably from 10 to 50 mm, particularly preferably from 15 to 25 mm. The length of the tip portions in contact with each other of a pair of blades provided in a facing disposition, when no light-sensitive material passes therethrough, is from about 1 to 10 mm, particularly from about 2 to 5 mm. This serves to ensure close contact of the tip portions of the blades when no light-sensitive material passes therethrough and effectively prevent migration of each processing solution. In addition, the amount of each processing solution entrained upon passage of the light-sensitive material can be minimized.

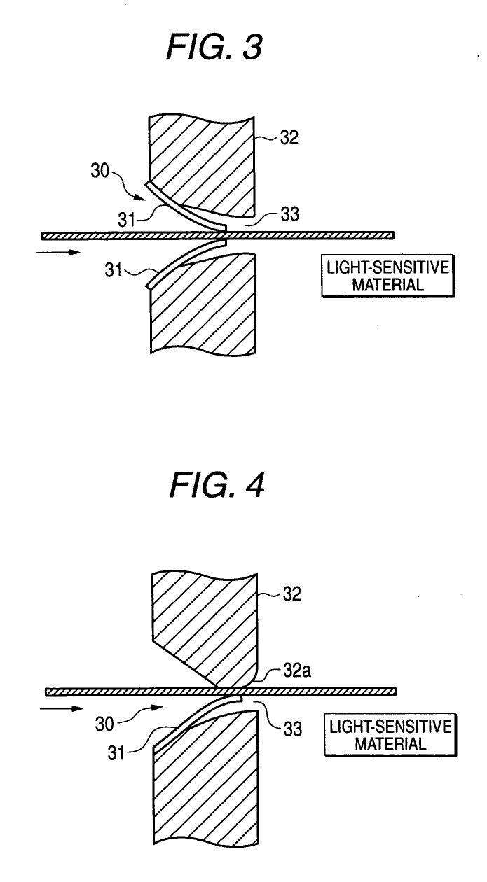

FIGS. 3 to 7 show various embodiments of the blades to be used for such purpose which, however, do not limit the use of other blades or other sealing means having the same function in the invention.

FIG. 3 is a cross-sectional view of the conveying passage in the solution showing the state wherein a pair of single blades are provided on the wall surface of the processing tank to form the conveying passage in the solution. In FIG. 3, a slit 33 is provided so that the light-sensitive material can migrate in the conveying direction shown by the arrow from the processing tank on the upstream side (left side of the tank wall 32) to the processing tank on the downstream side (right side of the tank wall 32). Also, the cross section of the tank wall 32 on the upstream tank side is in an oblique shape with respect to the passage so as to form an opening on the upstream side, and a pair of blades 31 are fixed on the oblique surfaces of the passage so that the free end pieces of the blades contact with each other on the downstream side and sandwich the light-sensitive material upon passage thereof. Thus, a pair of blades 31 contact with each other directly or via a light-sensitive material (or a conveyor belt) to form a sealing means 30 which prevents the processing solution of the upstream side tank and the processing solution of the downstream side tank from contacting with each other.

Therefore, when the development processing solution is out of operation, migration of the processing solution of the upstream side tank to the downstream side is stopped. During the development processing apparatus being in operation, the light-sensitive material is passed through the facing free ends of the blades in a state of occluding the upstream side processing solution in the light-sensitive layer thereof, which causes contamination of the downstream side processing solution with the upstream side processing solution. However, the degree of this contamination is a degree at which the advantages of the invention can be maintained, thus the sealing system using the blades being preferred as a sealing means for realizing the invention.

FIG. 4 is a cross-sectional view showing another embodiment of the sealing means. Like in FIG. 3, a single blade 31 is used. However, the blade is not paired and, on the other side of the passage for the light-sensitive material, one side of the light-sensitive material (or a guide film) is in contact with the tank wall 32, and the other side is in contact with the free end of the blade 31, thus a sealing means being formed by such structure. The slit end portion on the downstream side of the tank wall 32 in contact with the light-sensitive material (or the guide film) has a round portion 32a not to form scratches on the light-sensitive material.

FIG. 5 is a cross-sectional view of the conveying passage in the solution showing another embodiment of a sealing means using double blades 31a and 31b as a sealing means 30. In the tank wall 34 are formed oblique planes with respect to the passage for the light-sensitive material at two positions in the positional relation shown, and each of a pair of double blades 31a and a pair of double blades 31b are fixed with the free end of each blades being on the downstream side and the light-sensitive material being contacted with the blades vertically. Therefore, a two-stage sealing means 30 is formed which comprises the first sealing for sealing from the processing solution of the upstream tank by the free ends of a pair of the blades 31a and the light-sensitive material and the second sealing for sealing the processing solution of the downstream tank from the processing solution of the upstream tank having passed through the first sealing.

FIG. 6 is a cross-sectional view of the conveying passage in the solution showing another embodiment of a sealing means using double blades 31a and 31b as a sealing means 30 in a manner different from that in FIG. 5. In the tank wall 35 are formed oblique planes with respect to the passage for the light-sensitive material at two positions in the positional relation shown, and each of a pair of double blades 31a and a pair of double blades 31b are fixed with the free end of each blades being on the downstream side as is the same with the sealing means shown in FIG. 5. However, fine pores 37 are formed so that the processing solution confined in the space between the first sealing and the second sealing can go back to the upstream side tank. Therefore, when the water pressure in the middle portion between the first sealing and the second sealing becomes high, the processing solution in the middle portion goes back to the upstream side to prevent contamination of the processing solution on the downstream side.

Other functions are the same as have been described with respect to the double blade-type sealing portion shown by FIG. 5.

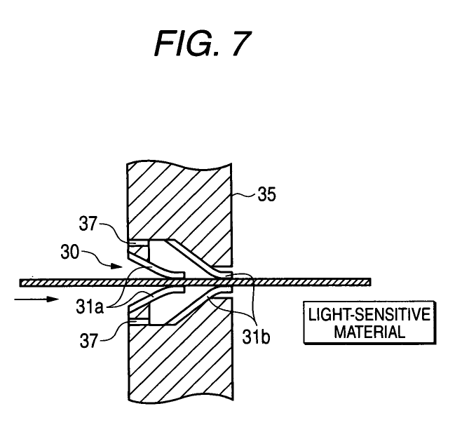

The embodiment shown in FIG. 7 is functionally the same as that shown in FIG. 6 in that the liquid pressure of the processing solution confined between the first sealing and the second sealing of the sealing means 30 using the double blades 31a and 31b is adjusted but, in the sealing system shown by FIG. 7, fine pores 37 are formed so that the processing solution confined between the first sealing and the second sealing can go back to the tank on the upstream side. Thus, when the water pressure in the middle portion between the first sealing and the second sealing becomes high, the processing solution in the middle portion goes back to the upstream side to prevent contamination on the downstream side.

Other functions are also the same as those described with respect to the double-blade type sealing portion shown by FIG. 6.

As to the material for the blade, any material may be used that does not exert detrimental effects on each processing solution. Examples thereof include elastic materials such as various rubbers exemplified by natural rubber, chloroprene rubber, nitrile rubber, butyl rubber, fluorine-containing rubber, isoprene rubber, butadiene rubber, styrene-butadiene rubber, ethylene-propylene rubber and silicone rubber and soft resins exemplified by polyurethane, soft polyvinyl chloride, polyethylene, polypropylene, ionomer resin, fluorine-containing resin and silicone resin. In particular, polyurethane is preferred in view of durability and resistance against leakage of solution.

The closely contacting force between the blades is given by the elastic force of the blade, and it is possible to compound a magnetic material in the tip portion of the blade (for example, like a rubber magnet) to generate an attraction force between the tip portions and give or increase the closely contacting force. Also, though detrimental influences such as formation of scratches on the emulsion surface of the light-sensitive material scarcely takes place when the light-sensitive material is conveyed in a rubbing condition with the blade, the inside surface of the blade may be subjected to a smoothing treatment or a surface treatment of coating a lubricant such as silicone or Teflon on the inside of the blade in the case where scratches are not negligible or where the rubbing resistance is intended to be reduced.

The linear velocity of the conveyance of the light-sensitive material in the development processing apparatus of the invention is preferably 100 mm/sec or less, more preferably from 20 mm/sec to 80 mm/sec, particularly preferably from 25 mm/sec to 60 mm/sec.

As to conveyance in the development processing apparatus for color paper, there are two types: one being a type of conducting development processing after cutting color paper into pieces of final size (sheet type conveyance); and the other being a type of cutting into pieces of the final size after conducting the processing (cine type). Since the cine type conveyance produces about 2-mm waste of the light-sensitive material between images, the sheet type conveyance is preferred.

The color paper to be subjected to the development processing apparatus of the invention may be either sheet-shaped or roll-shaped. As to conveyance of the light-sensitive material within the development processing apparatus, a roller-conveying system is employed in an apparatus for processing sheet-shaped color paper, and any of publicly related systems such as a roller-conveying system, a belt-conveying system and a leader-conveying system wherein a leader is attached to the tip of a roll may be employed in an apparatus for processing roll-shaped paper.

Various materials are used for components of the development processing apparatus, and preferred materials are described below.

Preferred materials for the tanks such as the processing tanks and temperature-controlling tanks include modified PPO (modified polyphenylene oxide) and modified PPE (modified polyphenylene ether) resin. The modified PPO is exemplified by NORIL manufactured by GE Plastics Co., and the modified PPE is exemplified by XYLON manufactured by Asahi Kasei corp. and UPIACE manufactured by Mitsubishi Gas Chemical Co., Inc. These materials are also appropriate for portions to be possibly in contact with the processing solution, such as a processing rack and a crossover.

As materials for the rollers in the processing zone, resins such as PVC (polyvinyl chloride), PP (polypropylene), PE (polyethylene) and TPX (polymethylpentene) are appropriate. Also, these materials can be used for other parts to be in contact with the processing solution. Additionally, PE resin is also preferred as a material for a replenisher tank to be made by blow molding.

As materials for the processing members, gears, sprockets and bearings, resins such as PA (polyamide), PBT (polybutylene terephthalate), UHMPE (ultra-high-molecular polyethylene), PPS (polyphenylene sulfide) and LCP (wholly aromatic polyester resin; liquid crystal polymer) are appropriate.

The PA resin is a polyamide resin such as 66 nylon, 12 nylon and 6 nylon, and those which contain glass fibers or carbon fibers are resistant against the swelling by the processing solution, thus being usable.

Also, high molecular products such as MC nylon and compression moldings can be used without a reinforcement by the fibers. As to UHMPE resin non-reinforced products are suited, with HI-ZEX MILLION manufactured by Mitsui Chemicals, NEWLIGHT manufactured by Saxin Corporation and SUNFINE manufactured by Asahi Kasei Chemicals Corp. being appropriate. The molecular weight thereof is preferably 1,000,000 or more, more preferably from 1,000,000 to 5,000,000.

As the PPS resin, those which are reinforced by glass fibers or carbon fibers are preferred. LCP resin includes VICTREX manufactured by ICI Japan, ECONOL manufactured by Sumitomo Chemical, XYDER manufactured by Nihon Sekiyu K.K. and VECTRA manufactured by Polyplastics.

Also, with an apparatus using a conveyor belt, the material for the belt is preferably an ultra-high strong polyethylene fibers described in Japanese Patent Application No. H-2-276886 or a polyvinylidene fluoride resin.

With an apparatus using squeeze rollers or the like, appropriate examples of the soft material for them include foamed vinyl chloride resin, foamed silicone resin and foamed urethane resin. The foamed urethane resin includes RUBICELL manufactured by Toyo Polymer Co., Ltd.

As materials for joints of piping and joints of agitation jet pipe and for rubbery members such as a sealing material, EPDM rubber, silicone rubber and VITON rubber are preferred.

In the development processing apparatus of the invention, the processing steps are characterized in that the bleaching processing is conducted subsequent to the color development, then processing with a processing solution having a fixing ability (a fixing solution or a bleach-fixing solution) is conducted. The processing wherein the processing with a bleaching solution and the processing with a fixing solution are separately conducted (also referred to as “separate type bleach-fixing”) is applied to light-sensitive materials for photographic use such as color negative films and has been used for processing color paper before year 1971 using a red prussiate-containing bleaching solution. However, processing of color paper has been changed to a bleach-fix processing since year 1971 using a bleaching agent of an iron ethylenediaminetetraacetate complex, and the separate type bleach-fix processing has become old-fashioned. In the invention, however, the separate type bleach-fix processing which is not being used at present in the development processing of color paper placed in the world market is applied to silver halide type color paper, and it has been found that exhaustion of both the bleaching solution and the fixing solution is extremely reduced and that both the bleaching time and the fixing time can be remarkably shortened and, in addition, that the processing solutions suffer less exhaustion with time even in non-busy seasons, thus development processing works being stably conducted. Further, there have been found advantages that the size of the processing apparatus can be reduced because of the shortened processing time, that the consumption amount of the processing solution can be reduced owing to the low exhaustion, and that the processing cost can be reduced.

Further, in ordinary color paper processing, there have often occurred troubles that, since the light-sensitive material having been subjected to the color developing step migrates to the bleach-fixing step with the color developer being occluded therein, bleaching fog or coloration failure (leuco dye trouble), and that tarry insolubles are generated and deposited onto the light-sensitive material. It has also been found that these troubles can be depressed by conducting the separate type bleach-fix processing.

A further advantage of the invention is also based on employment of the system of conveying a light-sensitive material in the solution between processing tanks by providing a passage for the light-sensitive material sealed without contacting air (in a solution-tight state) which permits passage of the light-sensitive material from the processing tank containing the bleaching solution and the processing tank containing the solution having a fixing ability. In a general-purpose development processing apparatus for color paper, conveyance of the light-sensitive material between the processing tanks is conducted by once taking the light-sensitive material out of the preceding processing tank and conveying the light-sensitive material in the air to the next tank. In the invention, however, at least conveyance in the air of the light-sensitive material from the processing tank containing the bleaching solution to the processing tank containing the solution having a fixing ability can be eliminated, which serves to shorten the processing time and reduce the size of the processing apparatus, leading to reduction in production cost of the apparatus. Also, since an opening of the processing tank containing the solution having a fixing ability can substantially be eliminated, deterioration of the solution having a fixing ability by air oxidation or evaporation can be depressed, thus fixing activity being stably maintained. This advantage serves to depress an increase in Dmin (yellow stain) which is liable to take place in a non-busy season or with a small-sized minilabo, thus contributing to stabilization and improvement of quality. Further, the low exhaustive property permits to reduce the consumption amount of the processing solutions and reduce the processing cost. In the invention, these advantages are obtained in addition to the aforementioned advantages of the separate type processing.

JP-A-7-234488 describes a development processing apparatus having a passage for a light-sensitive material sealed with blades. However, the passage for the light-sensitive material has a zone where the light-sensitive material is in contact with the air, and is not solution-tight. Therefore, the advantages of the invention can not be obtained by the apparatus described therein.

The development apparatus of the invention enables one to shorten the sum of the bleaching processing time and the time of processing with a solution having a fixing ability as short as 12 seconds or shorter by the rapid processing based on both the separate type processing system of using a bleaching solution and a solution having a fixing ability and the conveyance system of passing the light-sensitive material through the passage sealed without contacting air (in a solution-tight state) between the both tanks. The processing time can be reduced to 10 seconds or shorter, preferably 6 seconds or shorter. As to the limit of the shortened processing time, about 2 seconds are seemed to be the limit with respect to the bleaching time and the fixing time. However, as long as the light-sensitive material is subjected to the separate type bleaching step and the fixing step and is allowed to pass through the passage in the dipped solution sealed without contacting air (in a solution-tight state) and silver removal is completely conducted, the processing time is not limited on the shorter side.

A further advantage of the invention provided by the combination of the separate type processing wherein the bleach processing is combined with the processing with a solution having a fixing ability is that both the amount of replenisher for the bleach processing and the amount of replenisher for the solution having a fixing ability can be reduced. This replenisher amount reducing advantage may be attributed to that, since silver potential of the bleaching solution can be made higher than that of the bleach-fixing solution, there can be obtained a higher bleaching activity which serves to reduce the amount of consumed bleaching agent in proportion to the difference of the potential, and that exhaustion of the solution having a fixing ability by contamination with the bleaching solution is reduced, which serves to reduce the amount of consumed fixing agent in proportion to the difference in degree of exhaustion. A smaller amount of the replenisher leads to reduction in the amount of waste liquid discharged by overflow. Since it is only the waste liquid discharged from the bleach-fixing system that is a thick waste liquid discharged from the processing of color paper (a waste liquid from color development processing being in many cases substantially at a negligible level), it provides a great advantage that the waste liquid problem within the minilabo can be solved by entrusting a processing agent supplier to send back and process the waste liquid synchronously with the recovery of the containers for the processing agents (In the processing of color paper, a rinse overflow is also discharged. However, it is an aqueous solution containing components at a concentration of a much lower level, and hence a discharging method that can be employed in the minilabo can be selected. For example, it can be discharged to the sewage system after, as needed, recovering silver by adjustment of pH though depending upon conditions of local regulations.

Next, color processing steps to which the processing apparatus of the invention is applied are described below.

The color development processing to which the concentrated bleaching composition of the invention is applied comprises a color developing step, a bleaching step, a fixing step, a rinsing or water-washing step and a drying step. The processing solution in the fixing step may be a processing solution having a fixing ability such as a bleach-fixing solution as well as the fixing solution. As is described hereinbefore, a passage for a light-sensitive material sealed without contacting air (in a solution-tight state), through which the light-sensitive material can pass is provided between the bleaching step and the fixing step, and the light-sensitive material is conveyed through the passage in the solution between the processing tanks. However, conveying passages for the light-sensitive material between other steps are not limited to the type of conveyance in the solution, and a conveyance type of conveying the light-sensitive material in the air which thus requires an air time, may be employed. Preferably, the passages for the light-sensitive material in the whole dipping step of from the color developing step to the final rinsing step are preferably passages in the solution.

It is also possible to insert an auxiliary step such as an intermediate rinsing step, an intermediate water-washing step and a neutralizing step between the steps of dipping the light-sensitive material in the processing solutions. Also, in addition to the rinsing or water-washing step, an image-stabilizing bath may be provided between the rinsing or water-washing step and the drying step for the purpose of stabilizing an image.

The replenishing amount of the color developer is preferably from 10 to 200 ml, more preferably from 15 to 150 ml, most preferably from 20 to 90 ml, per m² of the light-sensitive material.

The replenishing amount of the bleaching solution and that of the fixing solution can be reduced, and is preferably from 5 to 30 ml, more preferably from 5 to 20 ml, most preferably from 5 to 15 ml, per m² of the light-sensitive material. The replenishing amount of the rinsing solution or washing water to the rinsing tank is preferably from 50 ml to 200 ml as the whole rinsing solution and, in the case of employing a multi-tank constitution as in the embodiment shown by FIGS. 1 and 2, a replenishing manner is suited wherein the final tank is replenished with the above-mentioned amount of the rinsing solution or washing water to cause overflow from the first rinsing tank according to the countercurrent cascade system.

Here, the color developing period is preferably 200 seconds or shorter, more preferably 120 seconds or shorter, still more preferably from 6 seconds to 80 seconds. Similarly, the bleaching period is 100 seconds or shorter, preferably 30 seconds or shorter, more preferably 15 seconds or shorter, still more preferably 10 seconds or shorter, further still more preferably from 2 seconds to 10 seconds, most preferably from 2 seconds to 8 seconds. The fixing period is 150 seconds or shorter, preferably 60 seconds or shorter, more preferably 40 seconds or shorter, still more preferably 30 seconds or shorter, further still more preferably 20 seconds or shorter, most preferably from 2 seconds to 10 seconds. The sum of the bleaching period and the fixing period is preferably within the aforementioned range, preferably 12 seconds or shorter, more preferably 10 seconds or shorter, still more preferably from 2 seconds to 6 seconds. Also, the rinsing or water-washing period is preferably 90 seconds or shorter, more preferably 60 seconds or shorter, still more preferably from 3 seconds to 30 seconds including the case of the multi-tank constitution being employed.

The temperature of the processing solutions in the color developing step, bleaching step, fixing step and rinsing step is generally from 30 to 40° C. However, it is also an embodiment of the invention to conduct an accelerated processing at an elevated temperature of from 38 to 60° C., more preferably from 40 to 50° C.

Additionally, the processing period of each step means a period of from dipping of the light-sensitive material into the processing solution of the step to dipping of the light-sensitive material into the processing solution of the next step. In the case of processing in an ordinary automatic developing machine, the processing period is a sum of the period of the light-sensitive material being dipped in the processing solution of the processing step and the period of the light-sensitive material being moved from the processing tank toward the processing solution of the next processing step in the air (so-called air time). In the development processing apparatus of the invention, the dipping period of the bleaching step coincides with the processing period. Also, the rinsing or water-washing period means the period of from entering of the light-sensitive material into the rinsing tank or the water-washing tank to entering of the light-sensitive material into the drying step.

Also, the amount of the rinsing solution can be determined from a wide range depending upon various conditions such as characteristics of the light-sensitive material (determined by, for example, materials used such as couplers), uses thereof, temperature of the rinsing solution (washing water), number (step number) of the rinsing solution (washing water), and the like. Of these, the relation between the number of tanks containing the rinsing solution (tanks containing the washing water) in the multi-step countercurrent system and the amount of water can be determined according to the method described in Journal of the Society of Motion Picture and Television Engineers, vol. 64, pp. 248-253 (the May number, 1955).

The step number in the multi-step countercurrent system is preferably from 3 to 10, particularly preferably from 3 to 5.

The multi-step countercurrent system serves to greatly reduce the amount of the rinsing solution and, since bacteria propagate to cause such problems as that a generated float deposits onto the light-sensitive material due to an increase in the residence time of water within the tank. Thus, in order to solve the problems, it is preferred to use a rinsing solution containing an antibacterial and antifungal agent to be described hereinafter.

The color paper having been subjected to development processing is subjected to the after-treatment such as the drying step. In the drying step, it is possible to absorb water by a squeeze roller or cloth immediately after development processing (rinsing step) in view of reducing the amount of water to be brought into the image membrane of color paper. Also, it is naturally possible to accelerate drying by raising the temperature or change the form of a blowing nozzle to strengthen the drying air. Further, as is described in JP-A-3-157656, drying can be accelerated by adjusting the blasting angle of the drying air or selecting the manner of removing the discharged air.

Next, the processing solution to be employed in the development processing apparatus of the invention is described below. First, a color developer to be used in color development is described below.

In the specification, in each step, a tank solution in the processing tank and a replenisher to be added to the processing tank are inclusively referred to as processing solutions (for example, a color developing replenisher being included in a color developer) unless it is necessary to specially distinguish them from each other.

The color developer contains a color developing agent.

Preferred examples of the color developing agent include related aromatic primary amine color developing agents, in particular, p-phenylenediamine derivatives. Typical examples thereof are illustrated below which, however, do not limit the invention in any way.
1) N,N-diethyl-p-phenylenediamine
2) 4-amino-3-methyl-N,N-diethylaniline
3) 4-amino-N-(β-hydroxyethyl)-N-methylaniline
4) 4-amino-N-ethyl-N-(βhydroxyethyl)aniline
5) 4-amino-3-methyl-N-ethyl-N-(β-hydroxyethylaniline
6) 4-amino-3-methyl-N-ethyl-N-(3-hydroxypropyl)aniline
7) 4-amino-3-methyl-N-ethyl-N-(4-hydroxybutyl)aniline
8) 4-amino-3-methyl-N-ethyl-N-(β-methanesulfonamido-ethyl)aniline
9) 4-amino-N,N-diethyl-3-(β-hydroxyethyl)aniline
10) 4-amino-3-methyl-N-ethyl-N-(β-methoxyethyl)aniline
11) 4-amino-3-methyl-N-(β-etoxyethyl)-N-ethylaniline
12) 4-amino-3-methyl-N-3-carbamoylpropyl-N-n-propyl-aniline
13) 4-amino-N-4-carbamoylbutyl-N-n-propyl-3-methyl-aniline
15) N-(4-amino-3-methylphenyl)-3-hydroxypyrrolidine
16) N-(4-amino-3-methylphenyl)-3-(hydroxymethyl)-pyrrolidine
17) N-(4-amino-3-methylphenyl)-3-pyrrolidinecarboxamide

Of the above-illustrated p-phenylenediamine derivatives, illustrative compounds 5), 6), 7), 8) and 12) are particularly preferred, with illustrative compound 5) and 8) being more preferred. When in a solid material state, these p-phenylenediamine derivatives are usually in the form of salts such as sulfates, hydrochlorides, sulfites, naphthalenedisulfonates or p-toluenesulfonates.

As to the amount of the aromatic primary amine developing agent to be contained in the processing agents, the color developing agent is added so that the concentration of the color developing agent in the color developer becomes 2 mmols to 200 mmols, preferably 6 mmols to 100 mmols, more preferably 10 mmols to 40 mmols, per L of the developer.

To the color developer may be added an organic preservative as a preservative. The organic preservative includes all compounds that can reduce, when added to the color developer, deterioration rate of the aromatic primary amine color developing agent. That is, the organic preservative is a compound having the function of preventing air oxidation of the color developing agent. Particularly effective organic preservatives include hydroxylamines, hydroxamic acids, hydrazides, phenols, α-hydroxyketones, α-aminoketones, sugars, monoamines, diamines, polyamines, quaternary ammonium salts, nitroxy radicals, alcohols, oximes, diamide comounds and ring-fused amines. These are described in the official gazettes or specifications such as JP-A-63-4235, JP-A-63-30845, JP-A-63-21647, JP-A-63-44655, JP-A-63-53551, JP-A-63-43140, JP-A-63-56654, JP-A-63-58346, JP-A-63-43138, JP-A-63-146041, JP-A-6344657, JP-A-63-44656, U.S. Pat. Nos. 3,615,503 and 2,494,903, JP-A-52-143020 and JP-B-48-30496.

As other preservatives, various metals described in JP-A-57-44148 and JP-A-57-53749, salicylic acids described in JP-A-59-180588, alkanolamines described in JP-A-54-3532, polyethyleneimines described in JP-A-56-94349 and aromatic polyhydroxy compounds described in U.S. Pat. No. 3,746,544 may be incorporated as needed. In particular, alkanolamines such as triethanolamine and triisopropanolamine, substituted or unsubstituted dialkylhydroxylamines such as disulfoethylhydroxylamine and diethylhydroxylamine, or aromatic polyhydroxy compounds may be added.

Of the above-mentioned organic preservatives, hydroxylamine derivatives are described in detail in JP-A-1-97953, JP-A-1-186939, JP-A-1-186940 and JP-A-1-187557. In particular, addition of both the hydroxylamine derivative and an amine is, in some cases, effective in the point of improving stability of color developer and stability upon continuous processing

Examples of the amine include cyclic amines as described in JP-A-63-239447, amines as described in JP-A-63-128340 and amines as described in JP-A-1-186939, JP-A-1-187557. The amount of the preservative in the processing solution varies depending upon kind of the preservative, but the preservative is added so that the concentration thereof in a solution to be used becomes 1 mmol to 200 mmols, preferably 10 mmols to 100 mmols, per L of the developer.

A chloride ion may be added, as needed, to the color developer for color paper. The color developer commonly contains chloride ion in a concentration of from 3.5×10⁻² to 1.5×10⁻¹ mol/L. Chloride ion is usually released into the developer as a by-product of development and, in many cases, a replenishing developer does not contain the chloride ion.

Since the light-sensitive material to be the object of the invention is color paper, it is not necessary to incorporate chloride ion in the color developer, but the solution may contain bromide ion in a concentration of 4.0×10⁻³ mol/L or less.

In the case of using chloride ion as an ingredient to be added to the color developer, examples of the chloride-supplying substance include sodium chloride, potassium chloride, ammonium chloride, lithium chloride, magnesium chloride, manganese chloride and calcium chloride. Of these, sodium chloride and potassium chloride are preferably used.

The pH of the color developer is preferably from 9.0 to 12.0, and the pH of the color developing replenisher is preferably from 9.0 to 13.5. Further, the pH of the color developer is more preferably from 9.0 to 10.5, and the pH of the color developing replenisher is preferably from 9.0 to 12.0. Therefore, an alkali agent, a buffer agent and, as needed, an acid agent may be added so as to maintain the pH level.

In preparing the color developer, it is preferred to use various buffer agents for the purpose of maintaining the pH at the above-mentioned level. Examples of the buffer agent to be used include carbonates, phosphates, borates, tetraborates, hydroxybenzoates, glycynates, N,N-dimethylglycynates, leucinates, norleucinates, guaninates, 3,4-dihydroxyphenylalaninates, alaninates, aminobutyrates, 2-amino-2-methyl-1,3-propanediol salts, valinates, prolynates, trishydroxyaminomethane salts and lysinates. In particular, carbonates, phosphates, tetraborates and hydroxybenzoates have the advantages that they are excellent in the buffering ability in the higher pH region of 9.0 or more in pH, that, when added to the color developer, they do not exert detrimental influences on photographic properties (e.g., fog), and that they are inexpensive. Thus, it is particularly preferred to use these buffer agents.

Specific examples of the buffer agent include sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (borax), potassium tetraborate, sodium o-hydroxybenzoate (sodium salicylate), potassium o-hydroxybenzoate, sodium 5-sulfo-2-hydroxybenzoate (sodium 5-sulfosalicylate) and potassium 5-sulfo-2-hydroxybenzoate (potassium 5-sulfosalicylate). However, in the invention, the buffer agents are not limited only to these compounds.

Since the buffer agent is not a component which reacts to be consumed, the addition amount thereof is determined so that the concentration thereof becomes 0.01 to 2 mols, preferably 0.1 to 0.5 mol, per L of the color developer.

To the color developer may be added other components for the developer. For example, there may be added various chelating agents which function both as agents for preventing precipitation of calcium or magnesium and as agents for improving stability of the color developer. Examples thereof include nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, trans-cyclohexanediaminetetraacertic acid, 1,2-diaminopropane-tetraacetic acid, glycol ether diaminetetraacetic acid, ethylenediamine-o-hydroxyphenylacetic acid, ethylenediaminedisuccinic acid (SS enantiomer), N-(2-carboxylatoethyl)-L-aspartic acid, β-alaninediacetic acid, 2-phosphonobutane-1,2,4-tricarboxylic acid, 1-hydroxyethylidene-1,1-diphosphonic acid, N,N′-bis(2-hydroxybenzyl)ethylenedivnine-N,N′-diacetic acid and 1,2-dihydroxybenzene-4,6-disulfonic acid.

These chelating agents may be used in combination of two or more thereof as needed.

The amount of the chelating agent is an amount which is sufficient to mask the metal ions in the color developer. For example, the chelating agent is added so that the amount becomes about 0.1 g to about 10 g per L of the color developer.

To the color developer of the invention may be added, as needed, any development accelerator. As the development accelerator, there may be added, for example, thioether compounds described in JP-B-37-16088, p-phenylenediamine compounds described in JP-A-52-49829, quaternary ammonium salts described in JP-A-50-137726, amine compounds described in U.S. Pat. No. 2,494,903, polyalkylene oxides described in JP-B-42-25201, 10-henyl-3-pyrazolidones or imidazoles as needed. The addition amounts thereof are determined so that the concentration of the accelerator becomes 0.001 to 0.2 mol, preferably 0.01 to 0.05 mol, per L of the developer and the replenisher prepared from processing agents.

To the color developer may be added, as needed, any antifoggant in addition to the aforementioned halide ion. Typical examples of the organic antifoggant include nitrogen-containing hetero ring compounds such as benzotriazole, 6-nitrobenzimidazole, 5-nitroisoindazole, 5-methylbenzotriazole, 5-nitrobenzotriazole, 5-chloro-benzotriazole, 2-thiazolyl-benzimidazole, 2-thiazolylmethyl-benzimidazole, indazole, hydroxyazaindolizine and adenine.

Also, to the color developer may be added, as needed, various surfactants such as alkylsulfonates, arylsulfonates, aliphatic carboxylates and aromatic carboxylates. The addition amount of the surfactant is determined so that the concentration of the surfactant becomes 0.0001 to 0.2 mol, preferably 0.001 to 0.05 mol, per L of the color developer and the replenisher prepared from the processing agents.

In the invention, a fluorescent brightening agent may be used as needed. As the fluorescent brightening agent, a bis(triazinylamino)stilbenesulfonic acid compound is preferred. As such bis(triazinylamino)stilbenesulfonic acid compound, related or commercially available bisaminostilbene series fluorescent brightening agents may be used. Examples of the related bis(triazinylamino)stilbenesulfonic acid compounds to be preferably used include those compounds which are described in JP-A-6-329936, JP-A-7-140625 and JP-A-10-140849. Examples of the commercially available compounds are described in, for example, Senshoku Noto, 9^{th} ed., published by Shikisensha, pp. 165-168. Of the compounds described there, Blankophor BSU liq. and Hakkol BRK are preferred. In incorporating the fluorescent brightening agent in the color developing agent, it is preferred to incorporate so that the concentration of the fluorescent brightening agent becomes 0.02 to 1.0 mol/liter.

As the bleaching agent to be used in the bleaching solution, any of related bleaching agents may be used. In particular, organic complex salts of iron (III) (e.g., complex salts of aminopolycarboxylic acids), organic acids such as citric acid, tartaric acid and malic acid, persulfates and hydrogen peroxide are preferred.

Of these, organic complex salts of iron(III) are particularly preferred in view of rapid processing and prevention of environmental pollution. Examples of useful aminopolycarboxylic acids (or salts thereof) for forming the organic complex salts of iron(III) include biodegradable ones such as ethylenediaminedisucinic acid (SS enantiomer), N-(2-carboxylatoethyl)-L-aspartic acid, β-alaninediacetic acid and methyliminodiacetic acid as well as ethylenediaminetetraacetic acid, diethylenetriaminepentaacetic acid, 1,3-diaminopropanetetraacetic acid, propylenediaminetetraacetic acid, nitrilotriacetic acid, cyclohexanediaminetetraacetic acid, iminodiacetic acid and glycol ether diaminetetraacetic acid. These compounds may be in any form of sodium salt, potassium salt, lithium salt and ammonium salt. Of these compounds, ethylenediaminedisuccinic acid (SS enantiomer), N-(2-carboxylatoethyl)-L-aspartic acid, β-alaninediacetic acid, ethylenediaminetetraacetic acid, 1,3-diaminopropanetetraacetic acid and methyliminodiacetic acid are preferred because the iron(III) complex salts thereof provide good photographic properties. These Ir(III) ion complex salts may be used in the form of complex salt or may be formed in situ in the solution by using a ferric salt such as ferric sulfate, ferric chloride ferric nitrate, ammonium ferric sulfate or ferric sulfate and a chelating agent such as an aminopolycarboxylic acid. It is also possible to use the chelating agent in an amount more than is necessary for forming the ferric ion complex salt. Of the iron complex salts, aminopolycarboxylic acid-iron complex salts are preferred.

The concentration of the bleaching agent in the bleaching solution is determined to be from 0.01 to 1.0 mol/liter, preferably from 0.03 to 0.80 mol/liter, more preferably from 0.05 to 0.70 mol/liter, still more preferably from 0.07 to 0.50 mol/liter.

The bleaching solution preferably contains various related organic acids (e.g., glycolic acid, succinic acid, maleic acid, malonic acid, citric acid and sulfosuccinic acid), organic bases (e.g., imidazole and dimethylimidazole), compounds represented by the general formula (A-a) described in JP-A-9-211819 including 2-picolinic acid and compounds represented by the general formula (B-b) described in the same official gazette including kojic acid. The addition amount of the compound is determined so that concentration of the compound in the prepared processing solution becomes preferably from 0.005 to 3.0 mols per liter, preferably from 0.05 to 1.5 mols per liter.

Also, addition of an alkali metal nitrate such as potassium nitrate or sodium nitrate is preferred because it serves to prevent corrosion of a metal-made member. The addition amount is determined so that the concentration of the nitrate in the prepared processing solution becomes from 0.005 to 3.0 mols per liter, more preferably from 0.05 to 1.5 mols per liter.

Further, addition of an alkali halide such as potassium chloride, potassium bromide, sodium chloride or sodium bromide is preferred because it serves to enhance the bleaching activity. The addition amount is determined so that the concentration of the alkali halide in the prepared processing solution becomes from 0.005 to 3.0 mols per liter, more preferably from 0.05 to 1.5 mols per liter.

The pH region of the bleaching solution to be used in the invention is preferably from 2 to 8, more preferably from 3 to 7, most preferably from 4 to 6. If the pH value is less than this, there results deterioration of the solution and acceleration of conversion of a cyan dye to its leuco form whereas, if the pH value is higher than this, there results a delayed silver removal and a tendency to generate stains. For the purpose of adjusting the pH, there may be added, as needed, acetic acid or an organic acid having been described hereinbefore, and the aforementioned alkali such as potassium hydroxide, sodium hydroxide, lithium hydroxide, lithium carbonate, sodium carbonate or potassium carbonate, or an acidic or alkaline buffer agent.

As the processing solution having a fixing ability, there are illustrated a fixing solution and a bleach-fixing solution. They are inclusively described below, provided that description on a bleaching component in the bleach-fixing solution having been already given with respect to the foregoing bleaching solution is not repeated. Compounds to be used as a fixing component in the fixing solution and the bleach-fixing solution are related fixing chemicals, i.e., water-soluble silver halide-dissolving agents such as thiosulfates (e.g., sodium thiosulfate and ammonium thiosulfate), thiocyanates (e.g., sodium thiocyanate and ammonium thiocyanate), thioether compounds (e.g., ethylenebisthioglycolic acid and 3,6-dithia-1,8-octanediol), and thioureas. These may be used independently or in combination of two or more thereof. In the invention, use of a thiosulfate is preferred, with use of ammonium thiosulfate being particularly preferred. The concentration of the fixing chemical in the fixing solution and the bleach-fixing solution is preferably from 0.3 to 3 mols, more preferably from 0.5 to 2.0 mols, per mol of the prepared solution.

The pH region of the fixing solution and the bleach-fixing solution to be used in the invention is preferably from 3 to 9, more preferably from 4 to 8. If the pH value is less than this, there results deterioration of the solution and acceleration of conversion of a cyan dye to its leuco form though silver-removing ability is improved whereas, if the pH value is higher than this, there results a delayed silver removal and a tendency to generate stains. For the purpose of adjusting the pH, there may be added, as needed, acetic acid or an organic acid having been described hereinbefore, and the aforementioned alkali such as potassium hydroxide, sodium hydroxide, lithium hydroxide, lithium carbonate, sodium carbonate or potassium carbonate, or an acidic or alkaline buffer agent.

Also, other various fluorescent brightening agents, antifoaming agents or surfactants, and polyvinylpyrrolidone may be incorporated in the fixing solution and the bleach-fixing solution. The fixing solution and the bleach-fixing solution preferably contain, as a preservative, a sulfite (e.g., sodium sulfite, a compound capable of releasing sulfite ion such as potassium sulfite or ammonium sulfite), a bisulfite (e.g., ammonium bisulfite, sodium bisulfite or potassium bisulfite) or a metabisulfite (e.g., potassium metabisulfite, sodium metabisulfite or ammonium metabisulfite) and an arylsulfinic acid such as p-toluenesulfinic acid or m-carboxybenzenesulfinic acid. These compounds are incorporated in a concentration of from about 0.02 to about 1.0 mol/liter in terms of sulfite ion or sulfinate ion.

As the preservative, ascorbic acid, a carbonyl-bisulfite addition product or a carbonyl compound may be added as well as the above-mentioned compounds.

In the rinsing solution, the technique of reducing the amounts of calcium and magnesium described in JP-A-62-288838 can be employed with an extreme efficiency. Also, it is possible to use isothiazolone compounds and thia-bendazoles described in JP-A-57-8542, chlorine-containing bactericides such as chlorinated sodium isocyanurate described in JP-A-61-120145, benzotriazole described in JP-A-61-267761, copper ion and bactericides described in Bokin Bobai No Kagaku, written by Hiroshi Horiguchi and published by Sankyo Shuppan (1986), Biseibutsu No Genkin, Sakkin, Bobai-gijutsu compiled by Eisei Gijutsu-kai (1982) and published by Kogyo Gijutsu-kai, and Bokin Bobaizai Jiten compiled by Nihon Bokin Bobai Kakkai (1986).

Light-Sensitive Material to be Processed

Next, the color photographic light-sensitive material to which the invention is applied is color paper, i.e., color photographic paper. This light-sensitive material comprises a support having provided thereon at least one light-sensitive layer. A typical example thereof is a silver halide photographic light-sensitive material comprising a support having provided thereon at least one light-sensitive layer comprising a plurality of silver halide emulsion layers substantially different in color sensitivity.

In the light-sensitive material for color print, a reflective support is generally used, on which a red-sensitive layer, a green-sensitive layer and a blue-sensitive layer are provided in this order from the far side with respect to the support. As the silver halide emulsion, cubic crystal emulsions of silver chloride grains or silver chlorobromide grains containing chloride in a high content are used.

The light-sensitive silver halide to be used for the light-sensitive material of the invention preferably comprises crystalline cubic or tetradecahedral grains substantially having a (100) face or a (111) face (these grains may have round tops or may have a higher face), grains having octahedral crystal lattice or tabular grains having a (100) face or a (111) face as a main face and having an aspect ratio of 2 or more. The aspect ratio is a value obtained by dividing the equivalent circular diameter for the projected area of the grain by the thickness of the grain. As to tabular grains whose main face comprises a (100) face or a (111) face, reference may be made to JP-A-2000-352794, col. 33 (P7) to col. 40 (P8). In the invention, cubic grains are most preferred. The size of the grain is preferably 0.5 μm or less, more preferably 0.4 μm or less, in terms of the length of the cube.

As the silver halide emulsion to be used in the invention, an emulsion containing silver halide grains with a specific silver halide composition is used. In view of rapid processability, the content of silver chloride must be 90 mol % or more, and is preferably 93 mol % or more, still more preferably 95 mol % or more. The content of silver bromide, which serves to provide contrasty image and excellent latent image stability, is preferably from 0.1 to 7 mol %, more preferably from 0.5 to 5 mol %. The content of silver iodide, which gives a high sensitivity in high intensity exposure and gives a contrasty image, is preferably from 0.02 to 1 mol %, more preferably from 0.05 to 0.50 mol %, most preferably from 0.07 to 0.40 mol %. The silver halide grains of the invention are preferably silver iodobromochloride grains, with silver iodobromochloride grains of the above-mentioned halogen composition being still more preferred . . .

The silver halide emulsion to be used in the invention preferably contains iridium. As an iridium compound, a 6-ligand-coordinated complex having 6 ligands and containing iridium as a center metal is preferred in order to uniformly introduce into silver halide crystals. One preferred embodiment of iridium to be used in the invention is a 6-ligand-coordinated complex wherein Ir is a center atom having Cl, Br or I as ligand. In this case, Cl, Br or I may be co-present. Incorporation of the 6-ligand-coordinated complex wherein Ir is a center atom having Cl, Br or I as ligand in the silver bromide-containing phase is particularly preferred for obtaining a contrasty gradation by high intensity exposure.

In the invention, the above-mentioned iridium complex is incorporated within silver halide grains preferably by adding the complex directly to a reaction solution upon formation of silver halide grains or by adding to an aqueous solution of halide for forming silver halide grains or to other solution to thereby add the complex to a grain-forming reaction solution. It is also preferred to conduct physical ripening with fine particles wherein the iridium complex is previously incorporated to thereby incorporate the iridium complex in the silver halide grains. Further, these methods may be combined to incorporate the complex in silver halide grains.

In the case of incorporating these complexes in silver halide grains, it may be conducted to allow them to exist uniformly within the grains. However, it is also preferred to allow the complexes to exist only in the surface layer of the grains, as disclosed in JP-A-4-208936, JP-A-2-125245 and JP-A-3-188437. It is also preferred to allow the complex to exist only in the interior of the grains and provide a complex-free layer on the surface of the grains. Also, as is disclosed in U.S. Pat. Nos. 5,252,451 and 5,256,530, it is preferred to modify the grain surface phase by fine particles containing the complex within them. Further, these techniques may be combined, or plural kinds of complexes may be incorporated in one kind of silver halide grains. There are no limits as to halogen composition of silver halide located at a position where the complex is incorporated. However, 6-ligand complexes which contain Ir as the central metal and wherein all of 6 ligands comprise Cl, Br or I are preferably incorporated in the portion where the concentration of silver bromide is maximal.

The optimal amount of the metal complex can vary depending upon the size of silver halide grains in which the complex is to be incorporated, but the complex is used in an amount of preferably from 5×10⁻¹⁰ mol to 1×10⁻⁷ mol, more preferably from 2×10⁻¹⁰ mol to 8×10⁻⁸ mol, particularly preferably from 5×10⁻¹⁰ mol to 5×10⁻⁸ mol, per inol of silver during formation of the grains.

In the invention, the interior and/or the surface of silver halide grains can be doped with other metal ion than iridium or rhodium. As such metal ion, transition metal ions are preferred. Of them, an ion of iron, ruthenium, osmium, lead, cadmium or zinc is preferred. Further, these metal ions are more preferably used as 6-ligand-coordinated octahedral complexes having ligands. In the case of using an inorganic compound as a ligand, cyanide ion, halide ion, thiocyanide ion, hydroxide ion, peroxide ion, azide ion, nitrite ion, water, ammonia, nitrosyl ion or thionitrosyl ion is preferably used. These ions may preferably be coordinated to any ion of the above-mentioned iron, ruthenium, osmium, lead, cadmium and zinc. It is also preferred to use plural kinds of ligands in one complex molecule. Also, an organic compound may be used as a ligand, and preferred examples thereof include chained compounds containing 5 or less carbon atoms and/or 5 or 6-membered hetero ring compounds. More preferred organic compounds are those compounds which have a nitrogen atom, a phosphorus atom, an oxygen atom or a sulfur atom within molecule as an atom which coordinates to the metal. Particularly preferred are furan, thiophene, oxazole, isoxazole, thiazole, isothiazole, imidazole, pyrazole, triazole, furazane, pyran, pyridine, pyridazine, pyrimidine and pyrazine. Further, those compounds wherein these compounds constitute a fundamental skeleton and a substituent or substituents are introduced to the skeleton are also preferred.

A preferred combination of the metal ion and the ligand is a combination of iron ion or ruthenium ion and cyanide ion. In the invention, it is preferred to use iridium and these compounds in combination. In the compounds, cyanide ion is preferably the majority of the ligands coordinated to the central metal of iron or ruthenium, with the rest coordination sites preferably being occupied by thiocyan, ammonia, water, nitrosil ion, dimethylsulfoxide, pyridine, pyrazine or 4,4′-bipyridine. It is most preferred that all of the 6 coordination sites of the central metal are occupied by cyanide ion to form hexacyano-iron complex or a hexacyano-ruthenium complex. These complexes containing cyanide ion as ligand is added in an amount of preferably from 10×10⁻⁸ mol to 1×10⁻² mol, most preferably from 1×10⁻⁶ mol to 5×10⁻⁴ mol, per mol of silver during formation of the grains. In the case where ruthenium or osmium is a center metal, it is preferred to have nitrosyl ion, thionitrosyl ion or water molecule and chloride ion at the same time as ligands. It is more preferred to form pentachloronitrosyl complexes, pentachlorothionitrosyl complexes or pentachloroaqua complexes, with hexachloro complexes being also preferred to form. These complexes are added in an amount of from 1×10⁻¹⁰ mol to 1×10⁻⁶ mol, more preferably from 1×10⁻⁹ mol to 1×10⁻⁶ mol, per mol of silver during formation of grains.

As spectrally sensitizing dyes to be used for spectral sensitization in green or red region of the light-sensitive silver halide emulsion for use in the invention, there are illustrated, for example, those which are described in F. M. Harmer, Heterocyclic compounds-Cyanine dyes and related compounds, John Wiley % Sons (New York, London), 1964. As to specific examples of the compounds and spectrally sensitizing methods, those which are described in the foregoing JP-A-62-215272, p. 22, right and upper column—p. 38 are preferably employed. Also, as red-sensitive spectrally sensitizing dyes for silver halide grains containing silver chloride in a high content, the spectrally sensitizing dyes described in JP-A-3-123340 are extremely preferred in view of stability, strength of adsorption and temperature dependence of exposure.

The silver halide emulsion to be processed in the development processing apparatus of the invention is preferably subjected to the gold sensitization related in the art. In the gold sensitization, various inorganic gold compounds, gold(I) complexes having inorganic ligands and gold(I) complexes having organic ligands can be utilized. As the gold compound, there may be used chloroauric acid or the salt thereof and, as the gold(I) complex having inorganic ligands, there may be used gold(I) dithiocyanate compounds such as potassium gold(I) dithiocyanate or gold dithiosulfate compounds such as trisodium gold(I) dithiosulfate.

It is also possible to use colloidal gold sulfide. Processes for producing it are described in Research Disclosure, 37154, Solid State Ionics, vol. 79, pp. 60-66 (1995), and Compt. Rend. Hebt, Seances Acad. Sci. Sect. B, vol. 263, p. 1328 (1966). It is described in the above-mentioned Reserch Disclosure to use thiocyanate ion upon production of colloidal gold sulfide. However, thioether compounds such as methionine and thiodiethanol may be used instead.

The gold sensitization may be combined with other sensitizing method such as sulfur sensitization, selenium sensitization, tellurium sensitization or reduction sensitization or with a noble metal sensitization using other compound than the gold compound. Particularly, it is proffered to be combined with sulfur sensitization and selenium sensitization.

Next, as a printer for preparing print by development processing using the development processing apparatus of the invention, a general-purpose printer may be used. The paper is also adapted to a scan exposure system using a cathode ray tube (CRT) in addition to the print system using an ordinary negative printer. In comparison with an apparatus employing a laser, the cathode ray tube exposure apparatus is simple and compact and is less costly. In addition, adjustment of optical axis or color is easy. As the cathode ray tube to be used for imagewise exposure, various light-emitting bodies capable of emitting light in the spectral region may be used. For example, one of a red light-emitting body, a green light-emitting body and a blue light-emitting body, or two or more thereof, may be used. The spectral region is not limited to the red, green and blue, and a fluorescent body emitting light in the region of yellow, orange, violet or infrared may also be used. In particular, a cathode ray tube emitting white light by mixing these light-emitting bodies is often employed.

The light-sensitive material to be processed in the development processing apparatus of the invention is preferably exposed by a digital scan-exposing system using a monochromatic high density light from, for example, a as laser, a light-emitting diode a semiconductor laser or a second harmonic-generating light source (SHG) wherein a solid-state laser using a semiconductor laser as an exciting light source is combined with non-linear optical crystals. In order to make the system compact and inexpensive, it is preferred to use a semiconductor laser or a second harmonic-generating light source (SHG) wherein a semiconductor laser or a solid-state laser is combined with non-linear optical crystals. In particular, in order to design an apparatus which is compact, inexpensive, long-lasting and highly stable, use of the semiconductor laser is preferred. At least one light source for exposure is preferably the semiconductor laser.

As to the preferred scan exposure system to be used in combination with the apparatus of the invention, detailed descriptions are given in the patents listed in the foregoing table. Also, processing materials and processing methods described in JP-A-2-207250, p. 26, right and lower column, line 1 to p. 34, right and upper column, line 9, and JP-A-4-97355, p. 5, left and upper column, line 17 to p. 18, right and lower column, line 20 can preferably be applied to the processing of the light-sensitive material of the invention.

### EXAMPLES

The invention is described more specifically by reference to Examples which, however, are not construed to be limitative of the scope of the invention in any way.

### Example 1

Light-Sensitive Materials Used for the Tests

Preparation of Emulsion BH-1 for Blue-Sensitive Layer

High silver chloride-content cubic grains were prepared by simultaneously adding silver nitrate and sodium chloride to a deionized distilled water containing deionized gelatin under stirring. During this preparation step, Cs₂[OsCl₅(NO)] was added from the point where addition of silver nitrate reached 60% to the point where addition of silver nitrate reached 80%. Potassium bromide (1.5 mol % per mol of finished silver halide) and K₄[Fe(CN)₆] were added from the point where addition of silver nitrate reached 80% to the point where addition of silver nitrate reached 90%. K₂[IrCl₆] was added from the point where addition of silver nitrate reached 83% to the point where addition of silver nitrate reached 88%. K₂[IrCl₅(H₂O)] and K[IrCl₄(H₂O] were added from the point where addition of silver nitrate reached 92% to the point where addition of silver nitrate reached 98%. Potassium iodide (0.27 mol % per mol of finished silver halide) was added under vigorous stirring at the point where addition of silver nitrate reached 94%. The thus-obtained emulsion grains were mono-disperse cubic silver iodobromochloride grains of 0.54 μm in side length and 8.5% in coefficient of variation. After subjecting this emulsion to a desalting treatment by sedimentation, gelatin, compounds Ab-1, Ab-2, Ab-3 and calcium nitrate were added, followed by re-dispersing the mixture.

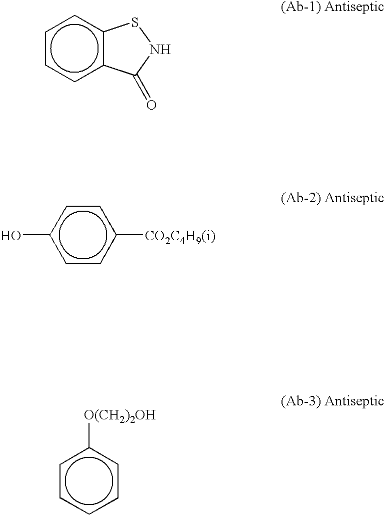

The re-dispersed emulsion was dissolved at 40° C., and sensitizing dyes S-1, S-2 and S-3 of the invention were added thereto so as to obtain optimum spectral sensitization. Subsequently, sodium benzenethiosulfate, a sulfur sensitizing agent of triethylthiourea, and a gold sensitizing agent of compound-1 were added to the emulsion, followed by ripening to attain optimum chemical sensitization. Subsequently, 1-(5-methylureidophenyl)-5-mercaptotetrazole, compound-2 and a compound represented by compound-3 wherein a major component is mainly 2 or 3 in the number of repeating unit (the end groups X1 and X2 being hydroxyl groups), compound-4 and potassium bromide were added to the emulsion to complete chemical ripening. The thus-obtained emulsion was referred to as emulsion BH-1. 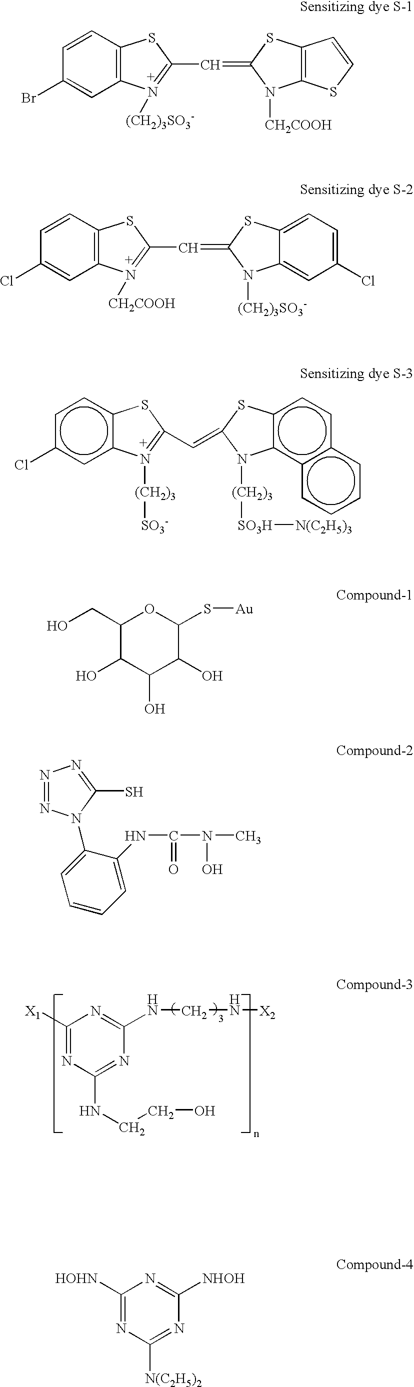
Preparation of Emulsion BL-1 for Blue-Sensitive Layer

Emulsion grains were obtained in the same manner as in preparation of emulsion BH-1 except for changing temperature and adding rate in the step of simultaneously adding and mixing silver nitrate and sodium chloride and changing the amounts of various metal complexes added during the addition of silver nitrate and sodium chloride. The resulting emulsion grains were mono-disperse cubic silver iodobromochloride grains of 0.44 μm in side length and 9.5% in coefficient of variation. An emulsion BL-1 was prepared in the same manner as with BH-1 except for changing the amounts of various compounds added after re-dispersing of the emulsion.

Preparation of Emulsion GH-1 for Green-Sensitive Layer

High silver chloride-content cubic grains were prepared by simultaneously adding silver nitrate and sodium chloride to a deionized distilled water containing deionized gelatin under stirring. During this preparation step, K₄[Ru(CN)₆] was added from the point where addition of silver nitrate reached 80% to the point where addition of silver nitrate reached 90%. Potassium bromide (2 mol % per mol of finished silver halide) was added from the point where addition of silver nitrate reached 80% to the point where addition of silver nitrate reached 100%. K₂[IrCl₆] and K₂[RhBr5(H2O)] were added from the point where addition of silver nitrate reached 83% to the point where addition of silver nitrate reached 88%. Potassium iodide (0.1 mol %) was added under vigorous stirring at the point where addition of silver nitrate reached 90%. Further, K₂[IrCl₅(H₂O)] and K[IrCl₄(H₂O)₂] were added from the point where addition of silver nitrate reached 92% to the point where silver nitrate reached 98%. The thus-obtained emulsion grains were mono-disperse cubic silver iodobromochloride grains of 0.42 μm in side length and 8.0% in coefficient of variation. This emulsion was subjected to the same desalting treatment by sedimentation and re-dispersing.

The resulting emulsion was dissolved at 40° C., and sodium benzenethiosulfate, p-glutaramidophenyldisulfide, a sulfur sensitizing agent of sodium thiosulfate pentahydrate and a gold sensitizing agent of (bis(1,4,5-trim ethyl-1,2,4-triazolium-3-thiolato) aurate (I) tetrafluoroborate) were added thereto and ripened so as to obtain optimum chemical sensitization. Subsequently, 1-(3-acetamidophenyl)-5-mercaptotetrazole, 1-(5-methylureidophenyl)-5-mercaptotetrazole, compound-2, compound-4 and potassium bromide were added to the emulsion. Further, in the course of the emulsion-preparing step, sensitizing dyes S-4 S-5, S-6 and S-7 were added to conduct spectral sensitization. The thus-obtained emulsion was referred to as emulsion GH-1. 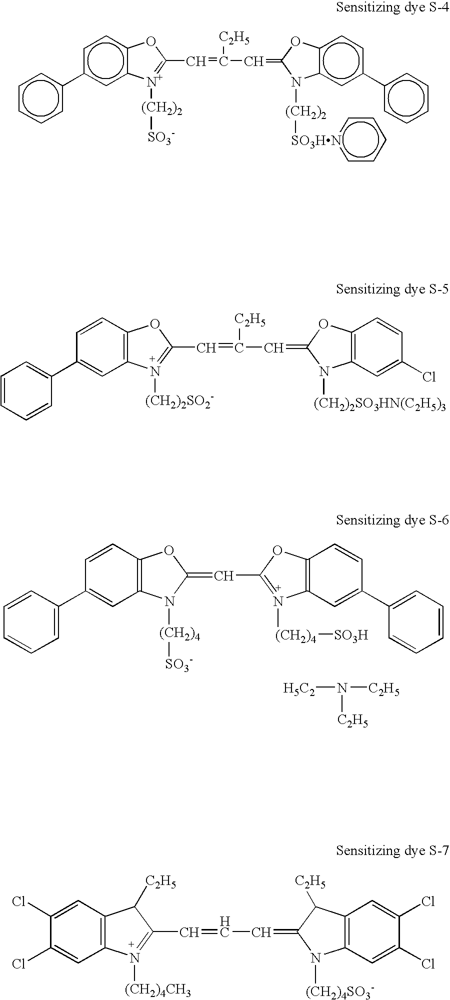
Preparation of Emulsion GL-1 for Green-Sensitive Layer

Emulsion grains were obtained in the same manner as in preparation of emulsion GH-1 except for changing temperature and adding rate in the step of simultaneously adding and mixing silver nitrate and sodium chloride and changing the amounts of various metal complexes added during the addition of silver nitrate and sodium chloride. The resulting emulsion grains were mono-disperse cubic silver iodobromochloride grains of 0.35 μm in side length and 9.8% in coefficient of variation. An emulsion GL-1 was prepared in the same manner as with GH-1 except for changing the amounts of various compounds added after re-dispersing of the emulsion.

Preparation of Emulsion RH-1 for Red-Sensitive Layer

High silver chloride-content cubic grains were prepared by simultaneously adding silver nitrate and sodium chloride to a deionized distilled water containing deionized gelatin under stirring. During this preparation step, Cs₂[OsCl₅(NO)] was added from the point where addition of silver nitrate reached 60% to the point where addition of silver nitrate reached 80%. K₄[Ru(CN)₆] was added from the point where addition of silver nitrate reached 80% to the point where addition of silver nitrate reached 90%. Potassium bromide (1.3 mol % per mol of finished silver halide) was added from the point where addition of silver nitrate reached 80% to the point where addition of silver nitrate reached 100%. K₂[IrCl₅(5-methylthiazole)] was added from the point where addition of silver nitrate reached 83% to the point where addition of silver nitrate reached 88%. Potassium iodide (0.05 mol %) was added under vigorous stirring at the point where addition of silver nitrate reached 88%. Further, K₂[IrCl₅(H₂O)] and K[IrCl₄(H₂O)₂] were added a the point where addition of silver nitrate reached 92% to the point where addition of silver nitrate reached 98%. The thus-obtained emulsion grains were mono-disperse cubic silver iodobromochloride grains of 0.39 μm in side length and 10% in coefficient of variation. The resultant emulsion was subjected to the same desalting treatment by sedimentation and re-dispersing as described hereinbefore.

The resulting emulsion was dissolved at 40° C., and a sensitizing dye S-8, compound-5, a sulfur sensitizing agent of triethylthiourea and a gold sensitizing agent of compound-1 were added thereto and ripened so as to obtain optimum chemical sensitization. Subsequently, 1-(3-acetamidophenyl)-5-mercaptotetrazole, 1-(5-methylureidophenyl)-5-mercaptotetrazole, compound-2, compound-4 and potassium bromide were were added to the emulsion. The thus-obtained emulsion was referred to as emulsion RH-1. 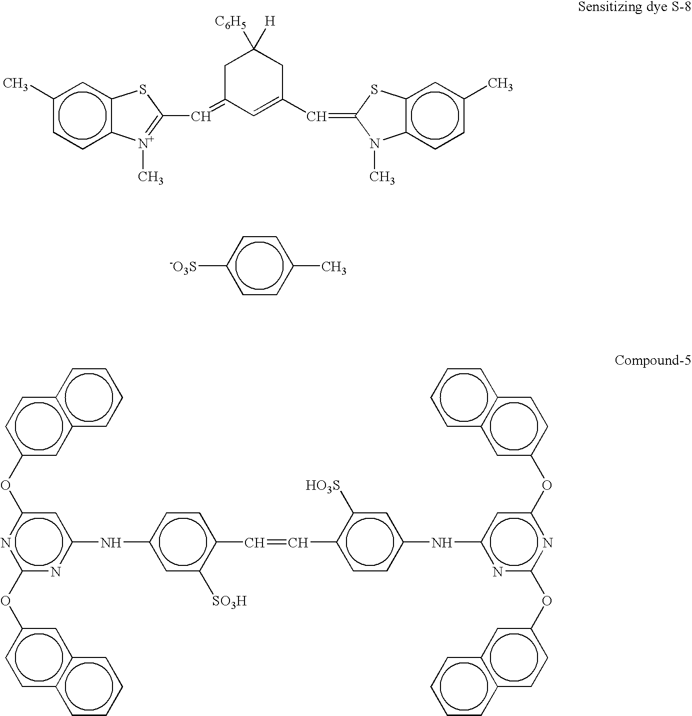
Preparation of Emulsion RL-1 for Red-Sensitive Layer

Emulsion grains were obtained in the same manner as in preparation of emulsion RH-I except for changing temperature and adding rate in the step of simultaneously adding and mixing silver nitrate and sodium chloride and changing the amounts of various metal complexes added during the addition of silver nitrate and sodium chloride. The resulting emulsion grains were mono-disperse cubic silver iodobromochloride grains of 0.29 μm in side length and 9.9% in coefficient of variation. An emulsion RL-1 was prepared in the same manner as with RH-1 except for changing the amounts of various compounds added after re-dispersing of the emulsion.

Preparation of a Coating Solution for the First Layer

34 g of a yellow coupler (ExY-1), 1 g of a color image stabilizing agent (Cpd-1), 1 g of a color image stabilizing agent (Cpd-2), 8 g of a color image stabilizing agent (Cpd-8), 1 g of a color image stabilizing agent (Cpd-18), 2 g of a color image stabilizing agent (Cpd-19), 15 g of a color image stabilizing agent (Cpd-20), 1 g of a color image stabilizing agent (Cpd-21), 15 g of a color image stabilizing agent (Cpd-23), 0.1 g of an additive (ExC-1) and 1 g of color image stabilizing agent (UV-2) were dissolved in 23 g of a solvent (Solv-4), 4 g of a solvent (Solv-6), 23 g of a solvent (Solv-9) and 60 ml of ethyl acetate, and the resulting solution was emulsified and dispersed in 270 g of a 20 wt % gelatin aqueous solution containing 4 g of sodium dodecylbensenesulfonate in a high-speed stirring emulsifier (dissolver), followed by adding water to prepare 900 g of an emulsion dispersion A.

On the other hand, the emulsion dispersion A was mixed with the emulsions BH-1 and Bl-1 to dissolve, and a coating solution for the first layer having the formulation described hereinafter was prepared. The amount of emulsion is in terms of silver amount.

Coating solutions for the second to seventh layers were prepared in the same manner as with the coating solution for the first layer. As a gelatin hardener for each layer, sodium salt of 1-hydroxy-3,5-dichloro-s-triazine (H-1), (H-2) or (H-3) was used. Also, Compounds Ab-1, Ab-2 and Ab-3 were added to each layer in total amounts of 15.0 mg/m², 60.0 mg/m², 5.0 mg/m² and 10.0 mg/m², respectively.

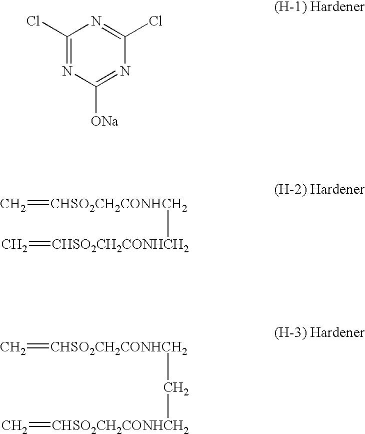

1-(3-Methylureidophenyl)-5-mercaptotetrazole was added to the second layer, the fourth layer and the sixth layer in amounts of 0.2 mg/m², 0.2 mg/m² and 0.6 mg/m², respectively. 4-Hydroxy-6-methyl-1,3,3a,7-tetrazaindene was added to the blue-sensitive emulsion layer and the green-sensitive emulsion layer in amounts of 1×10⁻⁴ mol and 2×10⁻⁴ mol per mol of silver halide, respectively. To the light-sensitive emulsion layer was added 0.05 g/m² of a methacrylic acid/butyl acrylate copolymer latex (1:1 in weight ratio; average molecular weight: 200000 to 400000). Disodium catechol-3,5-disulfonate was added to the second layer, the fourth layer and the sixth layer in an amount of 6 mg/m², 6 mg/m² and 18 mg/m², respectively. Sodium polystyrenesulfonate was added, as needed, to each layer for adjusting the viscosity of each coating solution. Also, in order to prevent irradiation, the following dyes (coating amounts being shown in parentheses) were added. 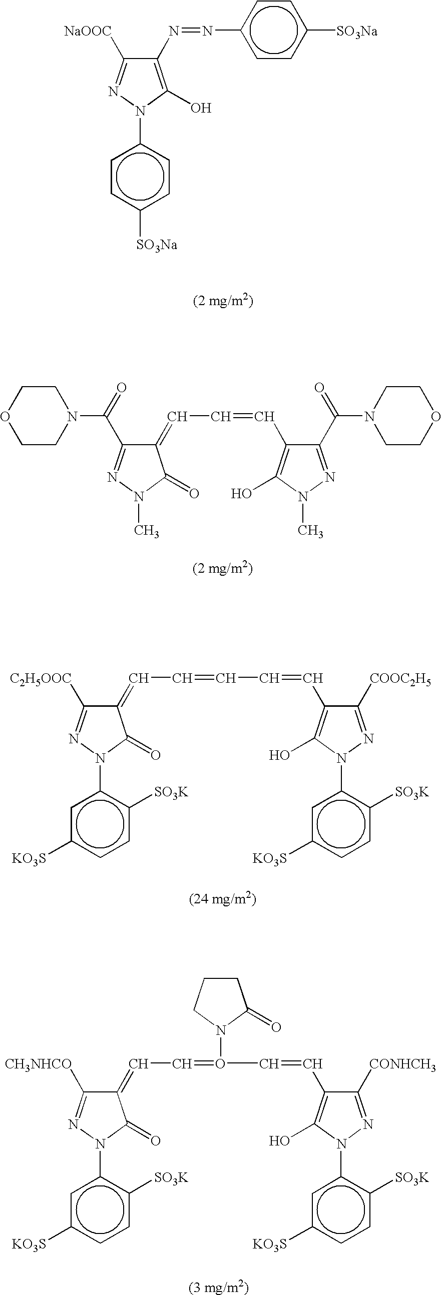
Layer Constitution

The constitution of each layer was shown below. Numerals represent coating amounts (g/m²). The amount of silver halide emulsion is represented in terms of the amount of coated silver.

Support

Polyethylene-Laminated Paper

[the polyethylene resin on the first layer side containing a white pigment (content of TiO₂: 16% by weight; content of ZnO: 4% by weight), a fluorescent brightening agent of 4,4′-bis(5-methylbenzoxazolyl)stilbene (content: 0.03% by weight) and a bluing dye of ultramarine (content: 0.33% by weight); the amount of polyethylene resin: 29.2 g/m²]

First layer (blue light-sensitive emulsion layer)

| | |
|---|---|
| Emulsion (5:5 (in molar ratio of silver) | 0.16 |
| mixture of BH-1 and BL-1) | |
| Gelatin | 1.32 |
| Yellow coupler (EX-Y) | 0.34 |
| Color image stabilizing agent (Cpd-1) | 0.01 |
| Color image stabilizing agent (Cpd-2) | 0.01 |
| Color image stabilizing agent (Cpd-8) | 0.08 |
| Color image stabilizing agent (Cpd-18) | 0.01 |
| Color image stabilizing agent (Cpd-19) | 0.02 |
| Color image stabilizing agent (Cpd-20) | 0.15 |
| Color image stabilizing agent (Cpd-21) | 0.01 |
| Color image stabilizing agent (Cpd-23) | 0.15 |
| Additive (ExC-1) | 0.001 |
| Color image stabilizing agent (UV-A) | 0.01 |
| Solvent (Solv-4) | 0.23 |
| Solvent (Solv-6) | 0.04 |
| Solvent (Solv-9) | 0.23 |

Second layer (color mixing-preventing layer)

| | |
|---|---|
| Gelatin | 0.78 |
| Color mixing-preventing agent (Cpd-4) | 0.05 |
| Color mixing-preventing agent (Cpd-12) | 0.01 |
| Color image stabilizing agent (Cpd-5) | 0.006 |
| Color image stabilizing agent (Cpd-6) | 0.05 |
| Color image stabilizing agent (UV-A) | 0.06 |
| Color image stabilizing agent (Cpd-7) | 0.006 |
| Antiseptic (Cpd-24) | 0.006 |
| Solvent (Solv-1) | 0.06 |
| Solvent (Solv-2) | 0.06 |
| Solvent (Solv-5) | 0.07 |
| Solvent (Solv-8) | 0.07 |

Third layer (green light-sensitive emulsion layer)

| | |
|---|---|
| Emulsion (1:3 (in molar ratio of silver) | 0.12 |
| mixture of GH-1 and GL-1) | |
| Gelatin | 0.95 |
| Magenta coupler (EX-M) | 0.12 |
| UV ray-absorbing agent (UV-A) | 0.03 |
| Color image stabilizing agent (Cpd-2) | 0.01 |
| Color image stabilizing agent (Cpd-6) | 0.008 |
| Color image stabilizing agent (Cpd-7) | 0.005 |
| Color image stabilizing agent (Cpd-8) | 0.01 |
| Color image stabilizing agent (Cpd-9) | 0.01 |
| Color image stabilizing agent (Cpd-10) | 0.005 |
| Color image stabilizing agent (Cpd-11) | 0.0001 |
| Color image stabilizing agent (Cpd-20) | 0.01 |
| Solvent (Solv-3) | 0.06 |
| Solvent (Solv-4) | 0.12 |
| Solvent (Solv-6) | 0.05 |
| Solvent (Solv-9) | 0.16 |

Fourth layer (color mixing-preventing layer)

| | |
|---|---|
| Gelatin | 0.65 |
| Color mixing-preventing agent (Cpd-4) | 0.04 |
| Color mixing-preventing agent (Cpd-12) | 0.01 |
| Color image stabilizing agent (Cpd-5) | 0.005 |
| Color image stabilizing agent (Cpd-6) | 0.04 |
| Color image stabilizing agent (UV-A) | 0.05 |
| Color image stabilizing agent (Cpd-7) | 0.005 |
| Antiseptic (Cpd-24) | 0.005 |
| Solvent (Solv-1) | 0.05 |
| Solvent (Solv-2) | 0.05 |
| Solvent (Solv-5) | 0.06 |
| Solvent (Solv-8) | 0.06 |

Fifth layer (red light-sensitive emulsion layer)

| | |
|---|---|
| Emulsion (4:6 (in molar ratio of silver) | 0.10 |
| mixture of RH-1 and RL-1) | |
| Gelatin | 1.11 |
| Cyan coupler (ExC-1) | 0.11 |
| Cyan coupler (ExC-2) | 0.01 |
| Cyan coupler (ExC-3) | 0.04 |
| Color image stabilizing agent (Cpd-1) | 0.03 |
| Color image stabilizing agent (Cpd-7) | 0.01 |
| Color image stabilizing agent (Cpd-9) | 0.04 |
| Color image stabilizing agent (Cpd-10) | 0.001 |
| Color image stabilizing agent (Cpd-14) | 0.001 |
| Color image stabilizing agent (Cpd-15) | 0.18 |
| Color image stabilizing agent (Cpd-16) | 0.002 |
| Color image stabilizing agent (Cpd-17) | 0.001 |
| Color image stabilizing agent (Cpd-18) | 0.05 |
| Color image stabilizing agent (Cpd-19) | 0.04 |
| Color image stabilizing agent (UV-5) | 0.10 |
| Solvent (Solv-5) | 0.19 |

Sixth layer (UV ray-absorbing layer)

| | |
|---|---|
| Gelatin | 0.34 |
| UV ray-absorbing agent (UV-B) | 0.24 |
| Compound (S1-4) | 0.0015 |
| Solvent (Solv-7) | 0.11 |

Seventh layer (protective layer)

| | |
|---|---|
| Gelatin | 0.82 |
| Additive (Cpd-22) | 0.03 |
| Liquid paraffin | 0.02 |
| Surfactant (Cpd-13) | 0.02 |

(Ex-Y)

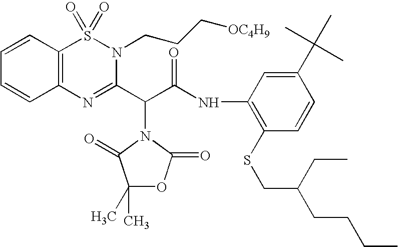

(Ex-M) magenta coupler: 40:40:20 mixture (molar ratio) of

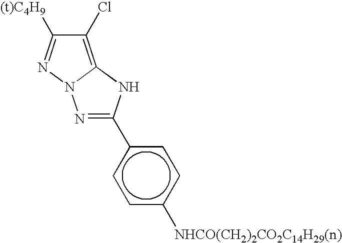

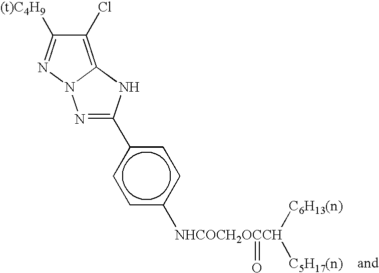

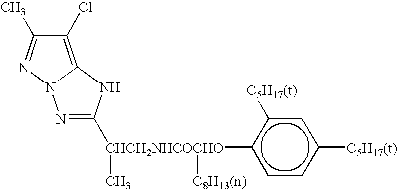

(ExC-1) cyan coupler

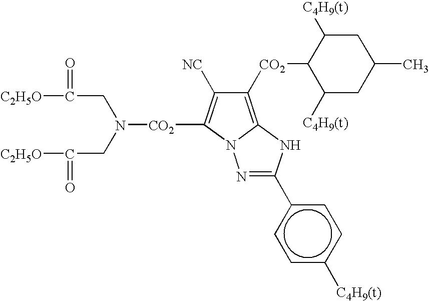

(ExC-2) cyan ooupler

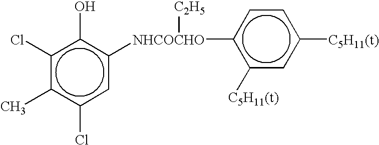

(ExC-3) cyan coupler

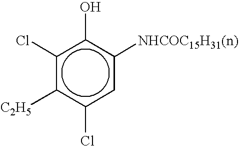

(Cpd-1) color image stabilizing agent

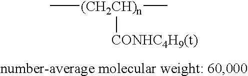

(Cpd-2) color image stabilizing agent

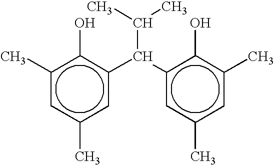

(Cpd-3) color image stabilizing agent

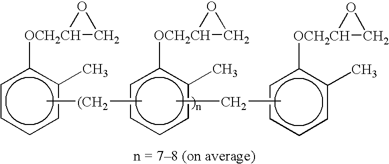

(Cpd-4) color mixing-preventing agent

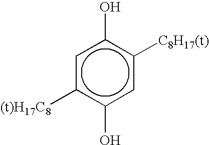

(Cpd-5) color image stabilizing agent

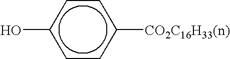

(Cpd-6) color image stabilizing agent

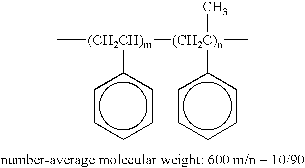

(Cpd-7) color image stabilizing agent

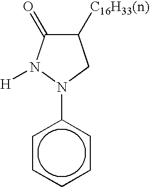

(Cpd-8) color image stabilizing agent

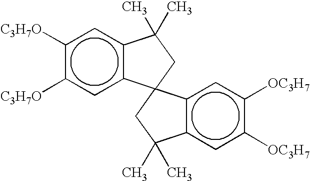

(Cpd-9) color image stabilizing agent

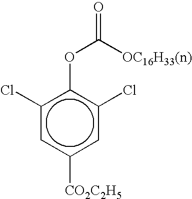

(Cpd-10) color image stabilizing agent

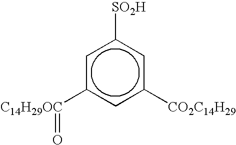

(Cpd-11)

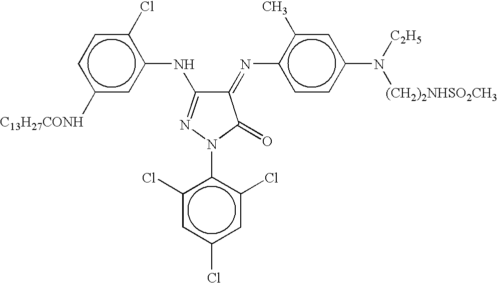

(Cpd-12)

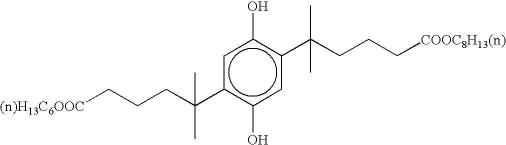

(Cpd-13) surfactant: mixture (6:2:2 in molar ratio) of (a)/(b)/(c)

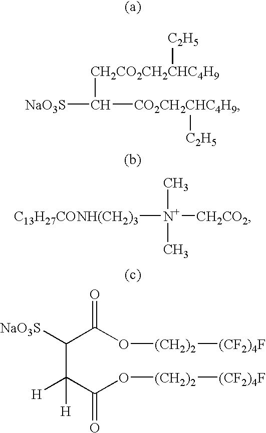

(Cpd-14)

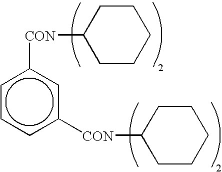

(Cpd-15)

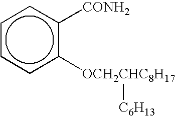

(Cpd-16)

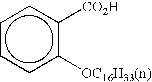

(Cpd-17)

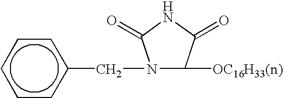

(Cpd-18)

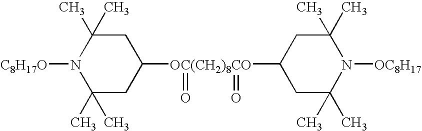

(Cpd-19)

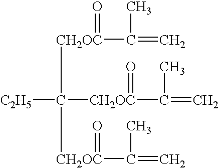

(Cpd-20)

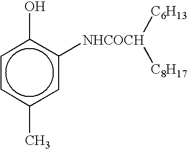

(Cpd-21)

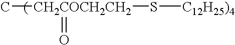

(Cpd-22)

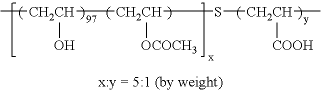

(Cpd-23)
KAYARAD DPCA-30 manufactured by Nihon Kayakiu K.K.
(Cpd-24)

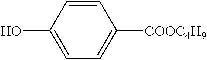

(Solv-1)

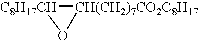

(Solv-2)

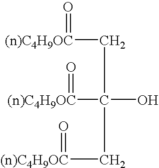

(Solv-3)

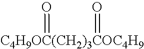

(Solv-4)
O═P(OC₆H₁₃(n))₃
(Solv-5)

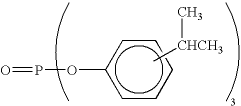

(Solv-6)
C₈H₁₇CH═CHC₈H₁₆OH
(Solv-7)

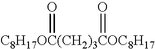

(Solv-8)

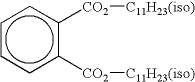

(Solv-9)

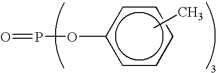

(S1-4)

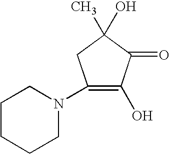

(UV-1) UV ray absorbing agent

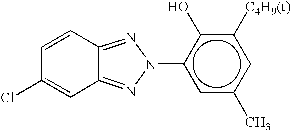

(UV-2) UV ray absorbing agent

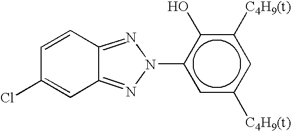

(UV-3) UV ray absorbing agent

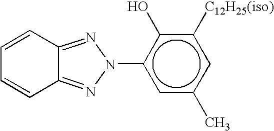

(UV-4) UV ray absorbing agent

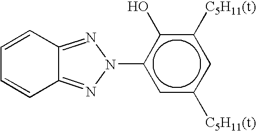

(UV-5) UV ray absorbing agent

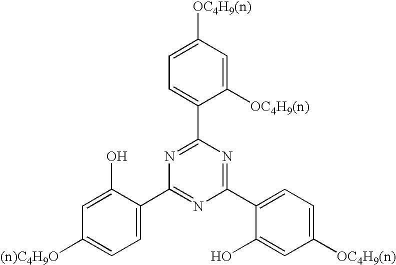

UV-A: a mixture of UV-1/UV-4/UV-5 = 1/7/2 (by weight)
UV-B: a mixture of UV-1/UV-3/UV-4/UV-5 = 1/3/5/1 (by weight)

The thus-prepared sample was referred to as sample 001.

2. Development Processing Test

The sample 001 was formed into a roll of 127 mm in width, and was exposed to a standard photographic image using Digital Minilabo Frontier 340 (manufactured by Fuji Photo Film Co., Ltd.). Then, continuous processing (running test) of the sample was conducted according to the following processing steps till the volume of the color developing replenisher became twice the volume of the color developing tank, provided that Frontier 340 (made by Fuji Photo Film Co., Ltd.) was modified so that the conveying speed of the processor provided the following processing periods and that the tank constitution was as shown in FIG. 1,

| Processing step | Temperature | Time | Replenishing Amount |
|---|---|---|---|
| Color development | 45.0° C. | 12 sec | 30 mL |
| Bleaching | 45.0° C. | 6 sec | 10 mL |
| Fixing | 40.0° C. | 3 sec | 10 mL |
| Rinsing 1 | 45.0° C. | 3 sec | — |
| Rinsing 2 | 45.0° C. | 3 sec | — |
| Rinsing 3 | 45.0° C. | 1.5 sec | — |
| Rinsing 4 | 45.0° C. | 1.5 sec | — |
| Rinsing 5 | 45.0° C. | 1.5 sec | — |
| Rinsing 6 | 45.0° C. | 1.5 sec | 80 mL |
| Drying | 80° C. | | |

Notes
*replenishing amount per m² of light-sensitive material
**Rinsing was conducted in a 4-tank countercurrent manner of from (1) to (6).

Formulation of each processing solution is as follows.

| | |
|---|---|
| [Tank soln.] | [Replenisher] |

[Color developer]

| Water | 800 | mL | 800 | mL |
|---|---|---|---|---|
| Fluorescent brightening agent (FL-1) | 4.0 | g | 9.0 | g |
| Residual color-reducing agent (SR-1) | 3.0 | g | 8.0 | g |
| Sodium p-toluenesulfonate | 10.0 | g | 10.0 | g |
| Ethylenediaminetetraacetic acid | 4.0 | g | 4.0 | g |
| Sodium sulfite | 0.10 | g | 0.10 | g |
| Potassium chloride | 10.0 | g | — | |
| Sodium 4,5-dihydroxybenzene- | 0.50 | g | 0.50 | g |
| 1,3-disulfonate | | | | |
| Disodium-N,N-bis(sulfonatoethyl)- | 8.5 | g | 14.0 | g |
| Hydroxylamine | | | | |
| 4-Amino-3-methyl-N-ethyl-N- | 7.0 | g | 17.5 | g |
| (β-methanesulfonamidoethyl)- | | | | |
| aniline 3/2 sulfate monohydrate | | | | |
| Potassium carbonate | 26.3 | g | 26.3 | g |
| Water to make the total | 1000 | mL | 1000 | mL |
| pH (25° C., adjusted with | 10.25 | | 13.0 | |
| sulfuric acid and KOH) | | | | |

[Bleaching solution]

| | | | | |
|---|---|---|---|---|
| Water | 800 | mL | 600 | mL |
| Citric acid | 19.2 | g | 67.2 | g |
| Sulfosuccinic acid | 19.4 | g | 67.9 | g |
| Iron(III) ammonium ethylene- | 47.0 | g | 164.5 | g |
| Diaminetetraacetate | | | | |
| Ethylenediaminetetraacetic acid | 1.4 | g | 4.9 | g |
| Nitric acid (67%) | 17.5 | g | 61.3 | g |
| m-Carboxysulfinic acid | 9.3 | g | 32.6 | g |
| Ammonium bromide | 50.0 | g | 150.0 | g |
| Water to make the total | 1000 | mL | 1000 | mL |
| pH (25° C., adjusted with | 5.00 | | 2.00 | |
| nitric acid and aqueous | | | | |
| ammonia) | | | | |

[Fixing solution]

| | | | | |
|---|---|---|---|---|
| Water | 800 | mL | 600 | mL |
| Ammonium thiosulfate (70%) | 0.3 | mol | 1.05 | mol |
| Ethylenediaminetetraacetic acid | 1.4 | g | 4.9 | g |
| Aminonium sulfite | 40.0 | g | 140.0 | g |
| Water to make the total | 1000 | mL | 1000 | mL |
| pH (25° C., adjusted with | 6.00 | | 6.50 | |
| nitric acid and aqueous | | | | |
| ammonia) | | | | |

[Rinsing solution]

| | | | | |
|---|---|---|---|---|
| Chlorinated sodium isocyanurate | 0.02 | g | 0.02 | g |
| Deionized water (conductivity: | 1000 | mL | 1000 | mL |
| 5 μs/cm or less) | | | | |
| pH (25° C.) | 6.5 | | 6.5 | |

FL-1

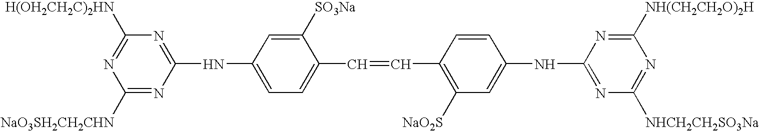

SR-1

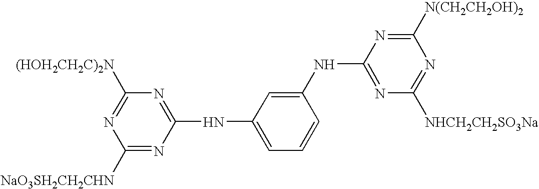

### Comparative Example 1

For the purpose of comparison, continuous processing (running) was conducted under absolutely the same conditions except for removing the wall between the bleaching tank and the fixing tank in FIG. 1 to combine them. Here, the tank formed by combining the bleaching tank and the fixing tank is a tank containing the related bleach-fixing solution and, as a starting solution, a 1:1 mixture of the above-mentioned bleaching solution and the fixing solution was used. Also, as to replenishment of the bleach-fixing solution, the above-mentioned bleaching replenisher and the fixing replenisher were separately introdued.

### Comparative Example 2

For the purpose of comparison, the same continuous processing was conducted using Frontier 340 (manufactured by Fuji Photo Film Co., Ltd.) except that the Frontier 340 was modified so that the conveying rate and the tank structure provided the following processing times.

| Processing Step | Temp. | Time | Replenishing Amount |
|---|---|---|---|
| Color development | 45.0° C. | 12 sec | 30 mL |
| Bleach-fixing | 45.0° C. | 8 sec | Bleaching part 10 mL |
| | | | Fixing part 10 mL |
| Rinsing 1 | 45.0° C. | 3 sec | — |
| Rinsing 2 | 45.0° C. | 3 sec | — |
| Rinsing 3 | 45.0° C. | 3 sec | — |
| Rinsing 4 | 45.0° C. | 3 sec | 175 mL |
| Drying | 80° C. | | |

Note
*replenishing amount per m² of light-sensitive material
**Rinsing was conducted in a 4-tank countercurrent manner of from (1) to (4).

Formulation of each processing solution is as follows.

| [Color developer] | [Tank soln.] | [Replenisher] |
|---|---|---|
| | same as above | same as above |

| | | |
|---|---|---|
| [Bleach-fixing solution in tank] | | |
| Water | 600 | mL |
| Citric acid | 19.2 | g |
| Sulfosuccinic acid | 19.4 | g |
| Iron(III) ammonium ethylene- | 47.0 | g |
| diaminetetraacetate | | |
| Ethylenediaminetetraacetic acid | 2.8 | g |
| Nitric acid (67%) | 17.5 | g |
| m-Carboxysulfinic acid | 9.3 | g |
| Ammonium bromide | 50.0 | g |
| Thioammonium sulfate (70%) | 0.3 | mol |
| Ammonium sulfite | 40.0 | g |
| Water to make the total | 1000 | mL |
| pH (25° C., adjusted with nitric | 6.00 | |
| acid and aqueous ammonia) | | |

| [Bleach-fixing replenisher] | [Bleaching part] |
|---|---|
| | same as the above-described |
| | bleaching replenisher |
| | [Fixing part] |
| | same as the above-described |
| | fixing replenisher |

(The bleaching part and the fixing part are separately directly introduced
into the bleach-fixing tank and mixed within the tank.)

| [Rinsing solution] | [Tank soln.] | [Replenisher] |
|---|---|---|
| | same as above | same as above |

Upon completion of the continuous processing, the amount of residual silver in the black high-density area of processed color paper and the yellow density of the white area (minimum density area) were measured. The results are shown in Table 1. Also, the concentration of the preservative (ammonium sulfite) in the rinsing solution 1 was measured. The results are shown in Table 1.

TABLE 1

| | Processor | | |
|---|---|---|---|
| | | | Bleaching |
| | Bleach-fixing | Bleach-fixing | Step + Fixing |
| | Step | Step | Step |
| | Comparative | Comparative | Example 1 |
| Note | Example 1 | Example 2 | (Present Invention) |
| Amount of | 4.3 | 5.0 | 0.3 |
| residual silver | | | |
| (μg/cm²) | | | |
| Concentration of | 0.1 | 0.1 | 4.2 |
| ammonium sulfite | | | |
| (g/l) in rinsing | | | |
| solution 2 | | | |
| Minimum yellow | 0.087 | 0.090 | 0.055 |
| density | | | |

In the processor of the Comparative Example 1 wherein the bleach-fixing tank was provided, there resulted an increased amount of residual silver in the black high-density area of color paper having been processed according to the above-mentioned rapid processing, thus desilvering failure occurring. Also, it was found that the preservative in the tank of rinsing 1 was consumed almost completely, and that there resulted an increased yellow stain in the white area of processed color paper due to deterioration of the rinsing solution.

In the bleach-fixing step of the Comparative Example 2 wherein the bleach-fixing tank was provided, there resulted an increased amount of residual silver in the black high-density area of color paper having been processed according to the above-mentioned rapid processing, thus desilvering failure occurring. Also, it was found that the preservative in the tank of rinsing 1 was consumed almost completely, and that there resulted an increased yellow stain in the white area of processed color paper due to deterioration of the rinsing solution.

### Example 2

Example 2 was prepared in the same manner in Example 1 except for changing the bleaching time of 6 see in development processing test to 5 sec. For the purpose of comparison, Example 2 was compared with Comparative Example 1 and Comparative Example 2 in the same way. The result was the same as in the Example 1, and any difference could not seen in the result of the invention between the bleaching time of 6 sec and 5 sec in development processing test.

In the processor shown in FIG. 1 wherein the processing of the invention is conducted, it was found that there remained almost no residual silver in the black high-density area in the rapid processing, thus desilvering being completed, and that the yellow density (stain density) of the white area was at a low level, with the concentration of preservative in the rinsing solution 1 being at a high level. Thus, it is seen that there is no problem at all with respect to stability of the rinsing solution.

Thus, it is seen that, in the continuous processing using the processing solution of the same formulation though there was the difference of whether separate type bleach-fix processing using two solutions is employed or combined bleach-fix processing using one bleach-fixing solution is employed, rapid processing can be realized with stably maintaining good image quality of high coloration density and low stain by using the processing steps of the invention and the processor of the constitution of the invention, in spite of extremely rapid processing.

The apparatus and method of the invention for processing silver halide color paper wherein the processing with the bleaching solution and the processing with the solution having a fixing ability are separated from each other, and the light-sensitive material is conveyed in the solution without contacting air between the both processings (a) realizes rapid processing permitting to hand over finished prints to a customer on the spot, (b) reduces the size of the processing apparatus thereby requiring only a small area allowable for a minilabo to install it, (c) ensures enough stability of processing solutions not to suffer deterioration of the processing solutions even during non-busy seasons because air oxidation of the fixing solution is depressed and deterioration with time due to contamination of processing solutions is reduced, and, therefore, (d) constantly maintains image quality at a normal level. Further, the method of the invention (e) enables to reduce the sum of the amount of bleaching solution and the amount of the processing solution having a fixing ability so much that the discharge amount of waste liquid of the photographic processing can be reduced.

The entire disclosure of each and every foreign patent application from which the benefit of foreign priority has been claimed in the present application is incorporated herein by reference, as if fully set forth

1. A development processing apparatus for a silver halide color paper, comprising;
a first processing tank for processing a light-sensitive material with a color developer;
a second processing tank for successively processing the light-sensitive material with a bleaching solution;
a third processing tank for successively processing the light-sensitive material with a solution having a fixing ability; and
a passage between the second processing tank and the third processing tank,
wherein the passage is sealed while the passage allows to pass the light-sensitive material, and the light-sensitive material is conveyed in a solution without contacting air through the passage between the second processing tank and the third processing tank.

2. The development processing apparatus according to claim 1,
wherein the second processing tank and the third processing tank are provided in a vertical positional relationship with each other.

3. The development processing apparatus according to claim 1,
wherein a sum of a processing time for processing with the bleaching solution and a processing time for processing with the solution having the fixing ability is 12 seconds or shorter.

4. The development processing apparatus according to claim 3,
wherein the sum is 10 seconds or shorter.

5. The development processing apparatus according to claim 1, further comprising:
a fourth processing tank for processing the light-sensitive material with a rinse solution; and
a passage between each adjacent two of the first processing tank, the second processing tank, the third processing tank and the fourth processing tank,
wherein the passage is sealed while the passage allows to pass the light-sensitive material, and the light-sensitive material is conveyed in a solution without contacting air through the passage.

6. A method for processing a silver halide color paper using a development processing apparatus for a silver halide color paper according to claim 1.

7. A method for processing a silver halide color paper comprising:
subjecting a light-sensitive material to processing with a color developer;
subjecting the light-sensitive material to processing with a bleaching solution; and
subjecting the light-sensitive material to processing with a solution having a fixing ability,
wherein the light-sensitive material is conveyed in a solution without contacting air between the processing with the bleaching solution and the processing with the solution having the fixing ability, and
wherein a sum of a processing time of the processing with the bleaching solution and a processing time of the processing with the solution having the fixing ability is 12 seconds or shorter.

8. The method according to claim 7,
wherein the sum is 10 seconds or shorter.

9. The method according to claim 7,
wherein a sum of an amount of a bleaching replenisher to be replenished into a bleaching tank and an amount of a replenisher having a fixing ability to be replenished into a processing tank for the solution having the fixing ability is 35 mL or less per m² of a color paper.

10. The method according to claim 7,
wherein the sum of the amount of the bleaching replenisher and the amount of the replenisher having the fixing ability is 25 mL or less per m² of a color paper.
